(19) United States
(12) Patent Application Publication
(10) Pub. No.: US 2002/0111891 A1
(43) Pub. Date: Aug. 15, 2002

(54) Accounting system for dynamic state of the portfolio reporting

(76) Inventors: Woodward Hoffman, Hoboken, NJ (US); Sean Togher, Jersey City, NJ (US)

Correspondence Address: HANDAL & MOROFSKY, 80 WASHINGTON STREET, NORWALK, CT, 06854, US

(21) Appl. No.: 09/997,716

(22) Filed: Nov. 26, 2001

Related U.S. Application Data
(60) Provisional application No. 60/253,057, filed on Nov. 24, 2000.

(51) Int. Cl. G06F 17/60

(52) U.S. Cl. 705/36

(57) ABSTRACT

The present invention relates to a data processing system capable of creating and maintaining the balances necessary for effective accounting of financial transactions by using a computed balance maintenance approach as opposed to the current standard event-driven, daily cycling approach. In particular, the data processing system creates nominal balances based on the life-to-date value of the instruments traded, then compares those nominal balances with the historic balances, and finally, creates the journal entries necessary to account for the differences between them, as opposed to the traditional approach of having daily entries drive accounting journals, which are then used as a foundation for subsequent account balance maintenance procedures. The data processing system thus comprises new and unique information transfer, storage and manipulation steps, and further comprises the creation and maintenance of dynamic links between declared investment strategies and the allocations of transactions to those strategies in order to meet the reporting requirements mandated by new accounting standards. The data processing system also provides a new and unique process that reassesses primary journal entries to create alternate homogeneous ledgers for analytic purposes, regulatory reporting purposes, or other purposes as are made possible by the inventive system.

### CROSS REFERENCE TO RELATED APPLICATIONS

This application claims the benefit of pending United States provisional patent application No. 60/253,057 filed Nov. 24, 2000, the disclosure of which is hereby incorporated herein by reference thereto.

### BACKGROUND OF THE INVENTION

1. Technical Field

The present invention relates to a novel method for reporting the state of a portfolio of financial instruments based upon a user driven, matrix of criteria.

2. Description of Related Art

There are accounting and business requirements respecting the recording of the acquisition and disposition of financial instruments and the state of a portfolio over time.

This need is currently satisfied through the performance, in separate environments, of recording and analysis of trading transactions and the accounting tasks required to report the state of the portfolio. The conventional separation of the functions specific to trading, from the functions specific to accounting, requires that the events, which occur on the trading side, must be synchronized with posting activities on the accounting side. Such systems rely heavily upon the capacity of personnel to select the proper information to use. Human errors and misjudgments introduce an uncertainty as to the possibility that information which is not correct may be introduced. Additionally, there is an uncertainty that an event, which has occurred on the trading side, may not be posted on the accounting side. The occurrence of either the introduction of incorrect information, or the failure to post a trading event presents the danger of system break-down.

Additionally, there is also a need to address new accounting regulatory requirements pertaining to reporting of the strategic purposes of transactions implemented by the manager, and to identify hedging relationships for those transactions. For example, reference is made to another Financial Accounting Standards Board (FASB) Statement No. 133, issued in June 1998 and entitled “Accounting for Derivative Instruments and Hedging Activities” (which has been modified by FASB Statement No. 138, which issued in June of 2000). FASB Statement No. 133 establishes accounting and reporting standards for derivative instruments and for hedging activities, and requires that all derivatives must be recognized, in the statement of financial position, as either assets or liabilities, and that such instruments must be measured at fair value.

Existing trading and analytic systems are not adequate to perform the required additional accounting tasks and existing accounting systems are not adequate to perform the required tasks attendant to mandatory reporting requirements.

### SUMMARY OF THE INVENTION

An accounting process of the type employing a general ledger specific to the particular area of financial portfolio management is provided in accordance with a present invention.

In accordance with the invention, accounts may be created in the subledgers and maintained by employing user-defined accounting rules associated with each account balance in conjunction with life to date information on the positions in a portfolio. The above accounting rules are referred to herein as meta accounts. The collection of all meta accounts are referred to herein as a master account.

In accordance with the information, a screen is output to a user. This screen calls for financial instrument terms and related information. The user enters into the screen the terms of a financial instrument, such as the start and maturity date, interest rate, payment periods and/or other information that may pertain to the particulars of the instrument. The terms of the financial instrument and other information on the instrument are then saved in a database table specific to instrument data. In accordance with the invention, the user is presented with an interface calling for trade information. The user inputs into the interface the name of an instrument having desired terms corresponding to those which one desires to implement in a particular trade the user also enters the trade date associated with the trade, the settle date associated with the trade, the trade quantity associated with the trade, the price associated with the trade, and a dealer name, as well as any other optional information associated with the trade. The user also has the option of entering an allocation. The allocation is symbolized by an allocation name, such as “deutsche mark hedged” or “deutsche mark hedging”. The allocation has an attribute of being a hedging or a hedged trade, and a descriptive strategy denominator, such as “deutsche mark currency”, saving the settle date, trade quantity, price, dealer name, allocation and any other optional information comprising trade details. The trade details are saved to a and table specific to trade data in a database. The database stores information respecting a plurality of instruments associated with a particular internal account. The above process of entering information is repeated for a plurality of trades.

In accordance with the invention, daily market data related to the instruments the user may hold or may plan to hold in the user's portfolio is collected. The market data is saved daily to provide a history of daily market data which is maintained in the database for that purpose.

The terms of the instrument are retrieved together with the details of the trade. The system then evaluates the value of the quantity of the instrument by applying the market data to the terms of the instrument and the trade details to determine value and any interest due to complete a mark to market process, as of the selected effective date, and output a set of marks saved into the database in a marks table. The user may also choose to enter in marks, which the may vary from those determined by the above application of market data to the terms of the instrument and the trade details, for the terms of the instrument and the trade details wherein the marks express the opinion of the user with respect to the value of the instrument. The system then applies the terms of the instrument and the trade details to the market data, and the set of marks to a set of data requests and calculation instructions to output data responsive to the data requests in the form of annotated trade events related to instruments in the internal account.

The annotated trade events are output in the form of output variable-value pairs associated with a particular instrument and other information comprising annotated trade event identification information, whereby variable-value pairs express such things as present value, interest paid to date, interest received to date, interest due to be paid, interest due to be received, and the like. The system then begins to process trade events by ordering the application of Meta account rules based upon standard accounting practices such that there is a logical ordering of Meta account processing. A place is designated in memory for receiving specified items of information to form a ledger balance. The first annotated trade event is then from memory. The first annotated trade event is evaluated by applying the applicable Meta account rules to determine if there is an offset. The application of Meta account rules are then reordered, if such reordering is required by the existence of an offset. Information called for by the first Meta account rule for calculating the balances affected by the first annotated trade event is then assembled. The annotated trade event is then associated with all other annotated trade events to which it is matched whereby the position associated with the trade event is reduced by a percentage if there is a match, where a match is defined by a Meta account matching rule. The associated trade events are then ordered on a first-in, first-out basis.

The percentage of a trade that is matched if the trade has been matched is then calculated. Based upon annotated trading events and applicable Meta account rules, a balance is computed and stored in the designated place in memory for receiving specified items of information to form a ledger balance.

The above associating, ordering, computing the percentage of a trade that is matched if said trade has been matched, computing a balance and storing in memory is repeated for all other Meta accounts in a repeated operation step. The above evaluating, assembling, associating, ordering, computing the percentage of a trade that is matched if said trade has been matched, computing a balance and storing in memory is repeated for all annotated trade events and the above repeated operation step are then repeated in a second repeated operation step.

The system then forms a set of the balances for the effective date. The user may they decide whether to instruct the system to mask trade details. The system generates a set of balances for all days prior to the effective date and polls all journal entry batches posted for the internal account being processed prior to the effective date. The system then calculates and constructs a historical set of balances. The set of balances are compared to the historical set of balances to obtain a difference. The system then generates journal entries based on the sets of balances, if the difference does not equal zero. The system then writes the journal entries. The system then posts the journal entries in the form of batches of journal entries which are saved to a database containing all journal entry batches previously posted.

In the event that the user has required further processing, employing any scripted set of rules, the system selects a first set of information from the posted journal entry batches, and a second set of information from the posted journal entry batches or other information derived from the journal entry batches. The first and second sets of information are evaluated with respect to each other to determine whether a further operation is required and the system then performs that further operation. In accordance with a preferred embodiment of the invention, it is contemplated that such further operation is the entry of certain journal entries in the event that balances between two accounts are of a nature that require the generation of new journal entries under certain accounting standards, as will be described in detail below.

### BRIEF DESCRIPTION OF THE DRAWINGS

The above and other aspects of the invention will be described in conjunction with the figures which only illustrate an illustrative embodiment of the invention, and in which:

FIGS. 1-4 illustrate a method of processing information which does not employ the method of the present invention;

FIGS. 5-6 illustrate a balance maintenance system employing the present invention;

FIG. 7 illustrates a screen for the input of information into a computer programmed with the method of the present invention;

FIG. 8 illustrates output variable value pairs generated by the system of the present invention;

FIG. 9 illustrates a screen listing various accounts contained in a master account in accordance with the present invention together with other information relating thereto;

FIG. 10 illustrates a screen presenting details on one of the accounts in FIG. 9;

FIG. 11 illustrates a screen presenting additional information in accordance with the present invention;

FIG. 12 is made an overview of some of the principal aspects of the inventive system;

FIG. 13 illustrates the accounting extract process and journal entry generation in accordance with the present invention;

FIGS. 14-17 together form a detailed flowchart of the inventive method of generating and posting journal entries; and

FIG. 18 is a flowchart illustrating second pass processing in accordance with the method of the present invention.

### DETAILED DESCRIPTION OF THE BEST MODE OF THE INVENTION

The value of the present invention may be understood when its performance is compared to the inadequacies of current data processing systems for handling the unique accounting needs for end users of derivatives. End users are firms with financial positions that present some risk of loss, and thus require a means of ameliorating that risk. For example, a financial institution in the business of making loans holds numerous instruments as a result of such transactions. As part of its investment strategy, it may choose to sell all or part of those instruments, or make other investments. A typical strategy is to hedge against potential losses or relatively low returns. This can be done by acquiring “standard” instruments that are available on the market, such as T-bills, or the like, which have characteristics that cause their value, interest, or other parameters to be such as to be likely to compensate expected losses or declines in returns in a hedged instrument. A very important part of contemporary strategies, however, involves the use of derivatives. Derivatives, which are explained in greater detail below, may be totally financial transactions in which parties exchange risks and rewards in accordance with negotiated terms usually tied to known indexes or the like. Such terms may vary greatly from instrument to instrument, and from portfolio manager to portfolio manager, and, in accordance with the invention, flexibility is provided to accommodate a full range of hedging strategies and instrument designs. Thus, an instrument may be a hedged instrument that is hedged by a derivative investment, or an instrument may be a hedging instrument designed to hedge the risk of a corresponding hedged investment.

At the same time, the invention accommodates the new reporting requirements with respect to hedging investments, simplifies accounting in the event of changes in data, whether due to human error in the data entry process, or in the event of other changes required because investment projections related to the instruments in a portfolio have changed. End users of the invention are likely to include corporations, governmental agencies, insurance companies, and other firms not directly involved as brokers or market makers in the financial trading industry.

Although the term “trade” is used in this discussion, the present invention is in no way an accounting system limited strictly to traded transactions. The present invention can be used to account for any cash positions that a firm wishes to maintain in its books and records. By the term “trade,” reference is made to a particular transaction in which a particular instrument is acquired. Thereafter, the property acquired in such transaction may be referred to as the “trade”. The term “trade” is used herein as a convenience, and to enable the discussion of all possible elements of the invention, which some cash positions would not necessarily employ. For example, the task of matching related transactions by dealer name, discussed later, may not apply to some cash positions.

New accounting regulations require firms to report the value of derivatives used to hedge transactions, and to demonstrate the strategic purposes of such a hedge, and to identify the relationship between a hedged trade and its hedging trade. In addition, traditional financial trading and risk analytics systems do not have the components required for such additional accounting tasks, and traditional accounting systems cannot handle the mandatory reporting, without additional operations. In contrast, the inventive method has the flexibility to reflect, in a single continuous process, allocations, or apportionments, of a single hedging trade to one or more hedging strategies, and to be able to change the allocations as conditions change for the firm's traded positions (for example, as when a portion of a hedging trade has been allocated to an additional hedging strategy), while still tracking the history of previous allocations. This is accomplished while still maintaining accurate balances, and implementing these regulatory reporting features with a processing efficiency that results in multiple uses of various processing steps.

A derivative is a financial instrument whose value depends on the value of an underlying financial element, e.g., the exchange rate of a foreign currency, or the rate of change in a market index such as Standard and Poors 500, also known as the S&P 500. As alluded to above, end users of derivative instruments use them to hedge a risk of loss related to or associated with investments or financial commitments. For example, if an agency has sold a ten year bond of $100 million an investor, meaning that only after ten years will the agency return the $100 million principal of the bond to the investor, and this will occur as a single lump sum payment of $100 million. In consideration of the loan, the agency will pay the investor five percent each year for 10 years on the $100 million, paid in quarterly payments each equal to 1.25% of the amount of the loan. In this example, the agency is worried that bond rates may fall over time, and so they may be paying the investor too high an interest rate if future bonds in the applicable currency pay in rates lower than 5% annually.

The agency can hedge the risk of falling bond rates by entering into a trade with a counterparty, usually someone other than the borrower, that involves a so-called 10 year fixed-floating LIBOR swap. This is an agreement between two parties that is evidenced by a derivative instrument where, for example, for ten years, the agency makes a swap agreement with a specific counterparty wherein the agency agrees to pay a floating three month LIBOR rate on that same amount and currency, while the counterparty (the other party to the agreement) agrees to pay a fixed rate of 5% on a specified notional amount and currency. The three month LIBOR rate is the London InterBank Offering Rate, an annual percentage, good for three months, that is thought to be reasonable for a loan involving that currency, and bond rates may be determined in relation to the current LIBOR rate offered. The three month LIBOR rate is called a “floating” rate, in that the rate resets every three months, according to prevailing market conditions. For the next ten years, every three months, the terms of the swap dictate that one of the two parties in the agreement will receive the difference between the fixed rate of 5% and the floating LIBOR rate.

Continuing the instant example, if the fixed rate of the swap agreement is five percent per year and the annual LIBOR rate set for the first quarter is 4.7569% per year, the agency, which agreed to pay the floating rate, has experienced a net gain for that quarter on the swap, which offsets the loss on the bond. If, however the LIBOR rate exceeds 5%, the agency pays the counterparty the difference between the LIBOR rate and 5%, but the bond is still profitable, because rates for any new bonds the agency might issue would now exceed 5%. Whichever way bond rates move, the agency has hedged the risk to the value of the bond with a successful hedging strategy.

In the past, derivative trades were not required to be reported on the books and records of a firm because they were intended to be used mainly as hedging trades for investment activities, and were not considered to significantly affect the financial profile. Over the years, hedge trading became more and more popular, but was still invisible to investors. This led to situations where some firms incurred massive debt and even collapsed as a result of aggressive derivative investments made by their portfolio managers using highly risk-laden derivative trades that proved unprofitable. Because of the lack of disclosure, investors in those firms experienced major losses through no fault of their own. As a result, accounting standards boards now require that positions in such instruments be marked to market. This means that firms are required to price each instrument according to its present fair value, and that value reported on the books and records of the firm, for the protection of the firm's investors and potential partners. One such board in the United States is the Financial Accounting Standards board, or FASB. FASB regulation 133, also known as FAS 133, requires that firms engaging in derivative trading must report all such investment activities, including income gains and losses relating to them, on their books and records. FASB has outlined some specific acceptable strategies, such as hedging the fair value of an instrument, hedging an expected cash flow, or hedging the risk presented by a foreign currency investment. Such strategies are accommodated by the method of the present invention. In addition, when using a derivative instrument in a hedging trade, firms must specify the hedging strategy for which such an instrument is being used, and must be able to demonstrate at any point in time the relationship between the hedged and hedging trade. By “relationship” is meant that a hedging trade of a named instrument and its present value is hedging the risk presented by another trade of a named instrument and its present value, and the strategy for using that hedging trade is declared. When it is desired to hedge a trade, there are a number of ways to hedge the risks associated with a financial instrument trade. For example, a single trade can be hedged with another single trade when there exists the reasonable expectation that if movement occurs in the direction of loss in the first trade, movement in the hedging trade in the direction of profit will offset the first trade's movement and reduce the loss. A single trade also can be hedged by a number of trades to spread the total risk over other types of instruments. Multiple trades can be hedged by a single trade designed to reduce the combined risk. Finally, a group of trades with common characteristics may be hedged by another group of trades with characteristics suited to offset the risk of the first group.

These one-to-one, one-to-many and many-to-many hedge relationships must be noted on the books of the firm and the strategies for hedging trades must be declared, and the allocations of trades to strategies must be demonstrable in terms of compliance reporting. Moreover, changes in the percentage at which a hedging trade has been allocated to a hedging strategy must be tracked in order to maintain correct compliance reporting.

Because many financial instruments have fluctuating values, there is an acceptable range in correlation between the hedged and hedging trades. FAS 133 considers a hedging trade to be effective if the changes in its values over time lie between 80% and 120% of the changes in value of the trade it is hedging. Where this is the case, FAS 133 does not require the gains or losses related to the hedging trade to be reported as capital gains or losses in the Income statement. It is permissible for those gains and losses to be reported in the Other Comprehensive Income (OCI) account, which does not affect the Income statement. However, when the value of a hedging trade exceed 120 percent of the hedged trade's value, or when the value of a hedging trade falls below 80% of the hedged trade, the excess gains or losses related to the hedging trade must be reported as capital gains or losses in the Income statement. Losses in excess of 80% demonstrate that a hedging trade is not effective, and so the excess amount of loss must be reported in the Income account, which ultimately affects the Income portion of the financial statements filed with regulatory agencies. The present invention provides a means of measuring the effectiveness of hedging trades, and of separating from the complete hedging positions only the amounts that must be reported in cases of excess profit or loss, and of generating only those journal entries required to update the Income account such that it is in compliance with regulatory reporting, all within a single continuous process.

Firms found not to be in compliance with the regulation to disclose the use of derivatives and their effect on the Income statement may find it difficult to conduct business nationally or internationally, as investors and potential business partners will be looking for information on the complete financial picture when making decisions about investing in or partnering with such a firm.

The Current State of the Art

In accordance with conventional practice in the current state of the art, subledger balances for the instruments held in a portfolio are maintained based on a system of generating journal entries daily in one database system, and then importing them to a second database for balance maintenance processing. These daily journal entries reflect changes to market values and trade-related events on a daily basis, but they cannot be used as a basis upon which to update the balances when a change occurs to any historical data relating to a trade, including changes to strategy allocations, discovery of errors, discovery of inaccuracies in predicted parameters or the like. A subledger is a set of ledgers and journals that may be linked to the general ledger for a firm, and in general, contain balances relating to a single area of financial activity, such as the activities related to the acquisition and disposition of financial investments.

If, in a conventional balance maintenance system, an error or change occurs in the any of the data used to generate subledger balances for a portfolio (i.e., if an error is made in a trade price, or a change is made to a hedging allocation, or projected rates are replaced by actual rates), all journal entries generated from the point in time that a change was made or an error occurred until the point in time the change was discovered or the error was corrected must be deleted from the journal entry system, and the deleted journal entries for each of those days must be regenerated. Then those corrected journal entries all must be imported into the subledger balance maintenance system. After that, the existing subledger balances must be reconciled. For many firms, this process may take several days, or even longer, for firms with very large trading subledgers.

The Alternative Provided with the Present Invention

In accordance with the invention, it is possible to provide an accounting system that generates correct balances from any point in the life cycle of a financial instrument. In addition, the inventive system is not dependent on daily journal entry processing to maintain balances. In accordance with the invention, the dependency on daily journal entry processing is eliminated by providing a means of retrieving, at any point in time, current market rates, historical market rates, and every detail of a trade and every element of the terms of the instrument traded. Examples of current market rates may include the most current Prime rate, the thirty year treasury rate, 3 month LIBOR rates, etc., as of a specified date. Historical market rates could include all previous resets of those rates. Examples of trade data could include the name of the instrument traded, the quantity, the internal account (the instrument's owner, from an internal perspective), the counterparty, the trade date, the settle date, the price, allocations to strategies, and other elements peculiar to trades involving complex financial instruments. Examples of instrument data could include the start date and maturity date of the instrument, the interest rate for one or both sides, the frequency of coupon payments, the schedules for amortizing or accreting principals, and other elements peculiar to complex financial instruments. When the information from these sources is retrieved, it may then be processed in a process unique to the present invention, to generate life-do-date balances for the subledger accounts that a firm wishes to maintain. These life-to-date balances are then compared with historic balances for the same accounts and any differences between the two sets of balances are noted in the form of journal entries.

Because the present invention does not require daily processing to maintain accurate account balances, the present inventive process can be initiated whenever the user desires to update the balances in a firm's accounts. Updates made to subledger balances by the inventive system may be made as frequently as every day, or as infrequently as once a quarter, or once a year, if desired. The present invention achieves this goal by first generating current market values by a mark-to-market process, explained later, or by using user-input marks (where valuation may be based on models, judgment, and/or other factors) to generate values for the instruments in a portfolio for the particular date. This pricing or other valuation is saved in a “marks” table. If changes were made to historical rates or other pricing data, or if changes were made to the details of the trade, or to the terms of an instrument traded, all of those changes are captured in the assemblage of the information by the inventive process in preparation for the next step. Historic rate settings may be centrally collected and downloaded daily, or at other suitable intervals, using the internet, modem to modem connection over telephone lines or the like.

The present invention then uses an inventive process, referred to herein as the “accounting extract,” to create accounting information in the form of variable/value pairs for every element of a trade reflecting current values (as in the case of the variable “Net Present Value” and its value) and life-to-date totals (as in the case of the variable “Interest Paid to Today” and its value). By variable/value pairs is meant the combination of 1) identification information, referred to as a “variable”, as is conventional in mathematical, scientific and related parlance and 2) quantitative information, referred to as a “value”. The variable/value pairs are calculated for an instrument by a process that combines the instrument's present value stored in the marks table, as described above, with all historic rate settings (such as all rate resets for the Prime rate since 1987), all trade-specific activity related to the instrument from life-to-date, and all instrument-specific information for the instrument traded. Thus the present value and every transaction that occurred in the life of the instrument from trade date to the present are retrieved and combined with the rates applicable to each transaction that occurred over time, said rates being extracted from the historical daily market data, then the values for specific variable are calculated. For example, for an instrument that pays a monthly coupon based on the prime rate plus a premium, the present invention would access all prime rate resets from the start date of the instrument until the present to calculate the total amount of payments made to date based on the traded quantity of the instrument. The process of calculating the variable/value pairs is repeated for each instrument held in the portfolio, and all of the variable/value pairs are stored in an inventive data structure.

Each one of these variable/value pairs are tagged with important items of information, such that each variable/value pair is labeled with the name of the “internal account” for which the process is being run (to establish perspective), the effective date (the date from which the marks of the instruments were taken), the mark thread (to establish which column of data in the marks table has provided the current marks of the instruments (i.e., the results of the mark-to-market process), the unique name of the instrument from which the specific value was taken, the unique trade identifier (generally a number) associated with the acquisition or sale of the instrument, the trade strategy (if any), the set of accounting rules that will be used in future processing steps), whether the item was or is to be paid or received by the internal account, the nominal currency (the currency specified in the terms of the instrument), and the functional currency (the currency in which balances are to be reported). The present invention is not limited in its ability to attach additional data.

The entire contents of the data file generated by the accounting extract process, described previously, are processed by an inventive journal entry generation process that employs the rules in the Master account to process the accounting extract data such that the result is a set of appropriate account balances for the effective date, and all the journal entries required to indicate the manner in which the balances were created or maintained. The resulting journal entries are saved in batch files that may then be posted to the subledger accounts. The Master account, as referred to in the invention, is a set of rules defined by the firm to specify how subledger account balances are to be created and maintained. The concept of a Master account is similar to the standard accounting concept of a “chart of accounts,” which also is a set of rules governing how a firm's subledger accounts are to be created and maintained.

The accounting rules contained in the Master account are implemented on the inventive system by the user, using a public domain scripting language to input the same into a computer on which the inventive system is operating. The Master account is built by the user in advance of any account processing, such that the rules will be in place to enable the generation and disposition of the journal entries.

The present invention also includes a novel process by which selected posted journal entries generated by the inventive balance maintenance system can be passed through a secondary process, herein referred to as the “second pass” in order to generate new journal entries for a specific set of account balances, as instructed by the second pass scripted processing rules, which implement an additional set of processing steps. For example, a “second pass” script could be used to form a ledger from the journal entries in a subledger account that currently reflect the net present value of two hedged and hedging instruments. The script could calculate the difference in value between the hedged and hedging instruments in order to generate additional journal entries that could then be posted to the appropriate Income account, if differences occur that exceed the tolerance of hedging trade values between 80% and 120% of the hedged trade.

If the difference in value between the two trades exceeds the tolerances for effectiveness as described above, the second pass script could calculate and generate a new set of journal entries. Because it is necessary to report differences that exceed the accounting standards limits, the script could then specify that new set of journal entries be posted to the affected accounts. Such calculations of new journal entries from previously posted journal entries and such balance updating is not directly possible if standard subledger balance maintenance system data processing steps and data structures are employed.

It is noted that in the calculation of the value of the instruments, the term “life-to date data,” used herein, refers to data on the instrument that begins with the implementation of the trade. However, the methodology of obtaining a particular valuation, which is not a part of the invention but that is performed using unrelated and conventional methods, may involve market data, instrument data, data related to the trade, data not related to the trade, economic data, monetary policy data, and other data that long predates the inception of the trade. Such information may be useful for valuation but is separate and apart from the inventive treatment of data once such a valuation for a particular trade has been determined.

The Inventive Methodology

The present invention provides a data processing system and method for creating and maintaining accounting entries by using a balance maintenance approach to maintain the balances in subledger accounts relating to a firm's financial instrument trading activities. In the present invention, initial trade data for the specific set of financial instruments associated with an internal account is used to create the original balances for the subledger accounts. In the present invention, the creation of the initial balances and their maintenance are all managed through a Master account, a term used in the present invention to mean a chart of accounts with rules for managing all journal entry creation and balance maintenance. In the present invention, the Master account contains one or more Meta accounts, a term used to describe a method of conveying the rule set for creating and maintaining specific journal entries. Maintenance of an account balance is achieved by first generating a nominal balance based on the compilation of present values and all transactions to date relating to the trades in a portfolio, then generating the prior balance from all of the historical journal entries for that subledger account, and finally comparing the nominal balance with the historic prior balance and generating new journal entries to maintain the correct balance.

Examples of ledger accounts maintained by the present system may be Assets, Liabilities, Income, Expense, Equity and Memo. Examples of the subledger accounts maintained by the present system may be Asset: Net Present Value, and Expense: Ineffective Portion Of Hedging Trade. Subledger accounts are named and configured by the user, and can be any name or configuration the user desires.

The present invention provides a new and unique means of allocating trades to declared trading strategies and of dynamically maintaining the links between strategies and allocations of transactions or portions of transactions to them. This enables firms to comply with new regulations governing the use of derivatives as imposed by national and international accounting standards boards (for example, Financial Accounting Standards Board (FASB), International Accounting Standards (IAS), etc.). In the present invention, hedging strategies are user-defined and are maintained in database tables, and can be associated with multiple transactions. At the time a trade is initiated and a position is acquired, the trade event is linked to a strategy via an allocation (as will be described in detail below.

By “primary” subledger accounts, used hereinafter, is meant the subledger accounts created by the present invention as a result of its balance maintenance processing. The use of the word “primary” is to distinguish those subledger balances from the balances generated by the second pass process.

The present invention provides a new and unique method embodied in the above second pass to create independent homogeneous ledgers and journals generated from previously posted journal entries. The “second pass” does not automatically update the primary subledger account, but provides a means of generating new, separate ledgers organized by key criteria, such as by currency, by dealer, by strategy, or other key elements, using only the posted journal entries needed to calculate or determine the parameters relating to that criteria. The retrieved journal entries are then processed according to a set of scripted processing commands associated with the above second pass. The resulting new journal entries are saved in a batch and can be posted to existing accounts in the primary subledger. The second pass is achieved through the use of the same public domain scripting language and through the use of the same accessors (methods used by the scripting language to access specific data, as described below) and functions (methods used by the scripting language to perform a mathematical or other operation on a particular item of information, as described below) used in the Meta account rules employed in the primary subledger processing.

In addition generating new journal entries from posted journal entries, the second pass processing has the ability to retrieve and examine the subledger journal entries specified in the second pass script, and to use those journal entries in the performance of any calculations contained in the script, and to output the results of the calculations as commanded by the second pass script.

Nominal and Functional Currencies

“Nominal” currency, as used herein, refers to the currency in which balances are initially created by a system operating in accordance with the present invention. Typically, the selection of nominal currency is based on the currency in which payments related to the trade being processed are to be made. Part of the balance maintenance process requires that a check be made to determine if the user specified a “functional” currency. Functional currency may be viewed as the currency in which one wishes to work on a daily basis, and is an optional setting that users may specify within a Master account or at the time the journal entry generation process is run. In accordance with the invention, a user has the option to specify that results generated by the balance maintenance process be converted into the functional currency. This is done by specifying within a Meta account for a given subledger account that functional currency processing be done on the nominal balance calculated. If a functional currency rule is included in a Meta account, all balances for that subledger account will be generated in the nominal currency and in the functional currency specified in the Master account or at the start of the journal entry generation process, according to the rules specified in the Meta account.

As is alluded to above, a Master account can be viewed as a collection of Meta accounts, with a particular account balance processing rule or rules associated with each Meta account. Thus, the Master account provides a complete set of user-defined rules for all primary balance maintenance functions desired by a user of the Master account.

Scripting Language

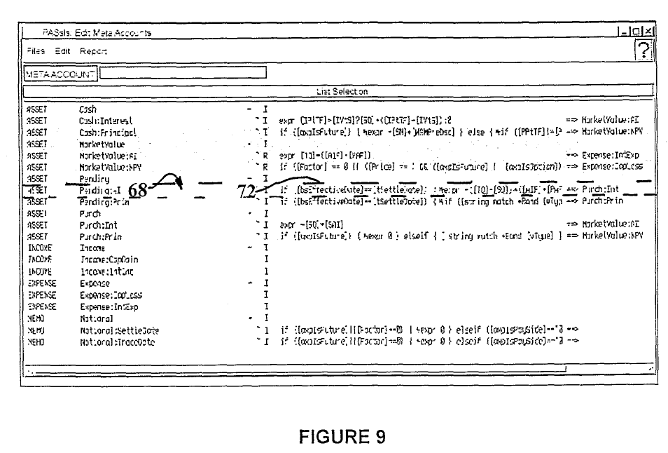

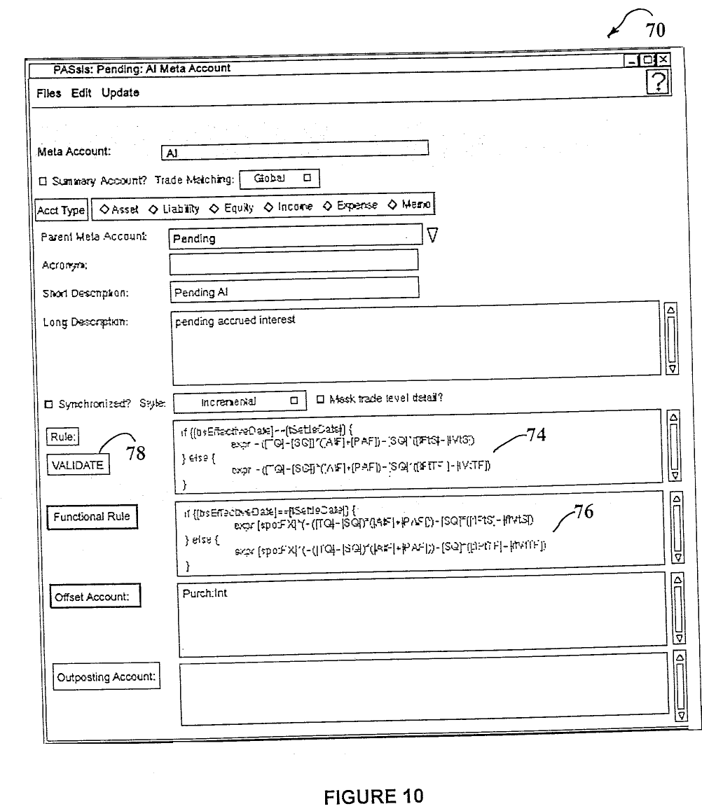

As noted above, the present invention uses a public domain scripting language to create scripts that direct the computer system to perform specific tasks. Any scripting language with a robust command set can be used by the present invention. Scripting languages are simpler to use than traditional programming languages such as C++, but have strong logic that can be combined with the accessors and functions particular to the present invention, as described below, to specify how data is to be generated and stored for generatingjoumal entries. Examples of scripting used in the present invention can be seen in FIGS. 9 and 10.

Strategies and Allocations and Their Links to Trades

In the present invention, and in compliance with accounting regulations, a “strategy” may be a statement of purpose made by a firm to explain the hedging strategy the firm employed when using a derivative instrument in a hedging trade. In the present invention, strategies may be created and defined by the user as being of type FV (fair value), CF (cash flow), or FC (foreign currency), and are maintained in database tables.

An allocation specifies the percentage of the trade that is to be applied to a strategy or a set of strategies. Allocations may be input into the system by the user and are maintained in database tables, and can be associated with multiple trades. An allocation to a strategy may be created in advance of making a trade, and may be defined by the user to specify what percent of a trade is allocated to which strategy, and may specify the hedging attribute (whether the allocated trade is being hedged or is hedging). For example, a user may create an allocation ‘H-0.5’ that specifies that all trades with this allocation will be hedging trades, and that 50% of the traded quantity will be allocated to Strategy A and 50% to Strategy B. The same user may create another allocation ‘D.1’ specifying that all trades with this allocation will be hedged trades, and that 100% of the traded quantity will be allocated to Strategy A. Then, when a trade is made that may present some risk, the hedged allocation H-0.5 linked to Strategy A could be specified. A subsequent hedging trade could be made that specifies the hedging allocation D.1 linked to both Strategy A and Strategy B. Through the trade recording mechanism, links are maintained dynamically between trades, allocations of those trades to strategies, and the strategy definitions. Allocations may be linked to a trade at the time a trade is initiated, but may also be specified after the trade has been made, and the present invention can accommodate this. Users can allocate portions of a trade to several strategies or all of a trade to a single strategy. Any association of a strategy with a trade or a portion of a trade is retained during the balance maintenance process and is permanently associated as an attribute with each journal entry generated from trade events related to the allocated trade. Allocations are optional, and are provided as a means of providing regulatory compliance for users of the inventive system.

Because the Strategy and Allocation details associated with a trade at the time of entry are all available at the transaction level throughout the balance maintenance process, reports can be generated that reflect the hedged and hedging relationships of trades based on the strategy they have in common. The Strategy (user-named and defined) and the Allocation attribute (whether the linked trade is hedged or is hedging) are stored automatically with each balance generated.

Mark-to-Market Process

As has been alluded to above, the term “mark-to-market” with respect to a trade means calculating the present value of each instrument in the portfolio using the prevailing market prices or user-entered prices for the date on which the mark-to-market is being performed, taking into consideration all the financial elements associated with the instrument, and the projected value of the future cash flows involved (coupon payments or other known cash flow events for the instrument) discounted to the present. For example, a $100 million bond that will pay 6% annually for the next ten years will have the future associated cash flows calculated and, through an algorithm, the total amount of the principal and the future cash flows will discounted to reflect today's vale, in order to take inflation and other factors into consideration. The prices output by this process are called “marks.” After the marks are calculated for each instrument, they are stored in the “marks” table, a database table created for that purpose. In the present invention, the mark-to-market process is run for a “thread,” an identifier the user selects that tells the data processing system which column in the marks table to use for inserting or retrieving the marks. The concept of threads enables users to generate multiple sets of marks for the same date if desired, one set of which actually may be used to create the journal entries that will be posted to a firm's books and records, and another set that may be entirely theoretical, for analytic purposes (such as a set of marks calculated from temporarily manipulated market data, which then can be used to generate theoretical account balances to view the effects of change to market rates).

The Accounting Extract

After a transacted instrument is marked-to-market with a value for a specific date, the present invention performs a process referred to in the present invention as an accounting extract. As the term suggests, an accounting extract extracts information from the trades and the instruments involved for an internal account, for a specific date (the effective date), using a specific set of marks (specified by the mark thread) generated on that date. In accordance with the invention, the accounting extract takes the form as an output of a plurality of variable/value pairs. The accounting extract process calculates and stores the current values for all the accounting elements that are required by the balance maintenance process to generate accurate and complete account balances. In the present invention, the accounting extract process examines the marks, the terms of the instruments traded, the details of the trades, and the historic rates related to the cash flows of the instruments, and then calculates and extracts information at the lowest level of a transaction, that is, it breaks down the assembled information into its smallest components, or “variables.” For example, one variable extracted may be the “Principal Paid to Today” from the perspective of the internal account, showing all principal paid on an instrument by the internal account from the trade date to today. The value associated with that variable is calculated starting from the initiation of the trade to the date the extract was run. The accounting extract process forms these variable/value pairs, and stores the results in a computer file. The variable/value pairs are organized into annotated trade events, described below, first by instrument, then by transactions related to the pay or receive side, the number of trades made for that instrument, and any allocations of the traded position to more than one strategy. Each annotated trade event is a complete set of variable/value pairs for the particular event.

The variable/value pairs generated by the accounting extract process provide a life-to-date snapshot of the instrument's associated transactions, from the date the instrument was first acquired to the Effective Date, the date for which the accounting extract is being processed. The effective date is always the same as the mark-to-market processing date. In the present invention, an accounting extract may be run for any date, but there must be marks in the marks table that were generated for the same date.

In accordance with the present invention, variable/value pairs are generated from both the trade date perspective (from the date on which an instrument was traded, such that ownership was transferred, or the date when a cash flow position was first acquired) and settlement date perspective (from the date on which all funds required to purchase the instrument were transferred from buyer to seller, and the initial trade transaction terms are considered, by both parties, to have been met). Generating variable/value pairs from both perspectives accommodates firms that desire accounting from one or the other date's perspective, or from both.

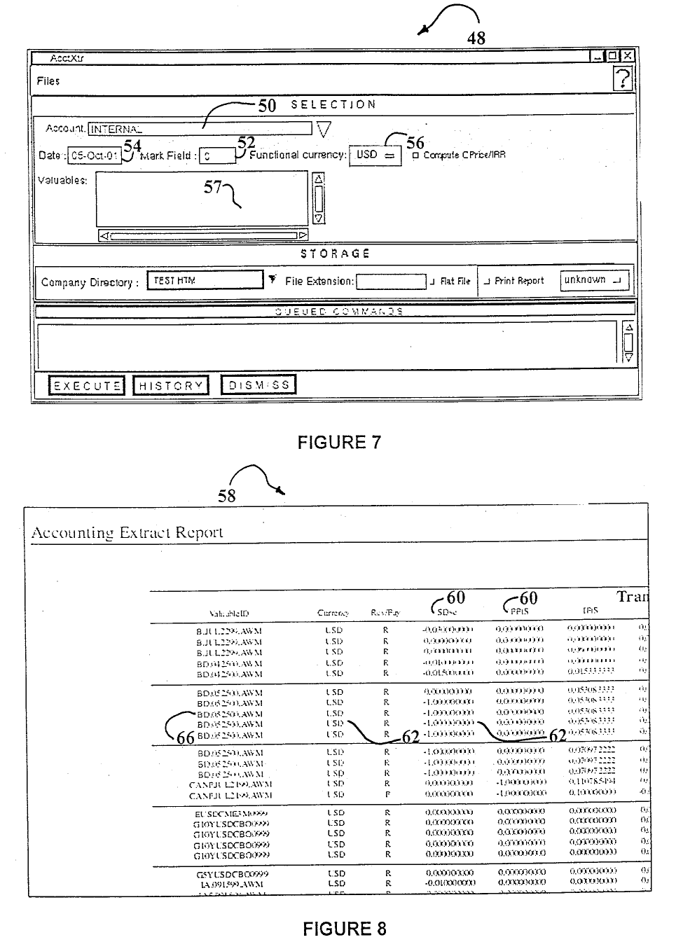

In accordance with the invention, if an instrument has only one side, as in the case of a bond, that is, if the internal account has an obligation to pay or to receive, but not both, the accounting extract will generate one annotated trade event with a complete set of the variable/value pairs for the related side. If the instrument has two sides, that is, the internal account has an obligation to pay side and to receive (as in the case of a fixed/floating swap where both parties have obligations to receive and to pay), the accounting extract will generate two annotated trade events, one complete set of the variable/value pairs for the pay side and one for the receive side, from the perspective of the internal account. In addition, if the trade of an instrument has an allocation assigned that does not allocate 100% of the trade to a single strategy (such as a trade involving $100 million of the 30 year treasury bill, assigned an allocation that dictates that 50% of that amount is allocated to hedge strategy A, 25% to hedge strategy B, and 25% unallocated), the accounting extract would generate three annotated trade events, one for the portion of the position allocated to hedge strategy A, and one for the portion of the position allocated to hedge strategy B, and one for the portion that is unallocated. The graphical display for generating an accounting extract is shown in FIG. 7, and a sample of some of the annotated trade events with the variable/value pairs generated by the accounting extract is shown in FIG. 8.

Master Account and Meta Accounts

In the present invention, a Master account is a means of specifying all of the rules required to maintain a firm's financial investment subledger accounts. Master accounts are user-defined and may be constructed to reflect the subledger accounting policies of a firm. Each Master account contains at least one Meta account with a rule or rules that define how journal entries for a specific account will be created when subledger balances are generated. Meta account “rules” specify the account in which a balance will be entered, any specifics as to how the account balance is calculated (for example, by specifying a mathematical formula), any offsetting journal entries that must be made to other accounts, the perspective from which the entry will be created, the style in which the entry will be made, i.e., incremental vs. reverse vs. reverse-by-reversal entry style, how trade matching will be handled, any functional currency rules, and more. Meta accounts also may contain rules that further specify what to do with a balance for a subledger account under very specific conditions.

For example, a Master account, which in the normal case would include all accounting rules for a specific area of the user firm's business, may be defined by a user to contain a Meta account called Asset:Pending:Accrued Interest, which would reflect the Asset account in which interest accrued to date for an instrument is maintained, and another Meta account called Asset:Purchase Interest, which would reflect the Asset account in which interest due upon purchase of an instrument is maintained. The Meta account Asset:Pending:Accrued Interest could contain instructions to generate offsetting journal entries for the account Asset:Purchase:Interest, if that account is affected by credit activity in said Asset:Pending:Accrued interest account. In this example, the present description of the inventive system refers to such account relationships as “offset accounts.”

A Meta account can also, in another sense, be seen as a template for specifying how an account balance will be processed regardless of the specifics of the instrument or the trade. For example, nominal currency is an attribute of a traded instrument. The nominal currency is the currency specified for payments in an instrument. A user does not have to define a Meta account for every currency that may be processed through the present invention. Unless a rule in the Meta account explicitly casts to a currency, the Meta account will allow any currency to be processed and segregated correctly by currency in the balances that are generated within the journal entry generation (“jeGen”) process. Meta account rules may specify the rule for processing the balances, and such things as which journal entries to create for which accounts, the parent subledger account into which the balances of the current (child) subledger account can be consolidated (for example, an asset account called “pending” may be a parent account to several child accounts that keep track of various items of pending payments or receipts, such as pending principal and pending accrued interest, that are totaled in the “pending” account), the type of account (asset, liability, income, etc.). Meta account rules may also specify whether the previous account balance is to be synchronized with the new balance, the journal entry style, trade matching type, trade level detail masking, any functional currency processing rules, any offset accounts, and other information. Rules may be settings that are selected, such as the journal entry style, or they may be scripted rules specifying formulas and calculations, and other special handling. The nature of these rules and how they function is described in detail below, in connection with the detailed description of the journal entry generation process.

As stated above, Meta accounts are provided as a means for comparing balances currently residing in the journal accounts with newly generated journal entries containing balances calculated from inception-todate. More particularly, Meta accounts may contain rules for generating balances, and provide a means for specifying the accounts in which those balances will be entered, and how resulting journal entries will be created to maintain the account, and specify any offsets. Meta accounts reside within the Master account for a firm. The graphical display provided by the present invention for viewing the list of Meta accounts held in a sample Master account is shown in FIG. 9, and the graphical display provided by the present invention for a sample Meta account is shown in FIG. 10.

The Journal Entry Generation Process

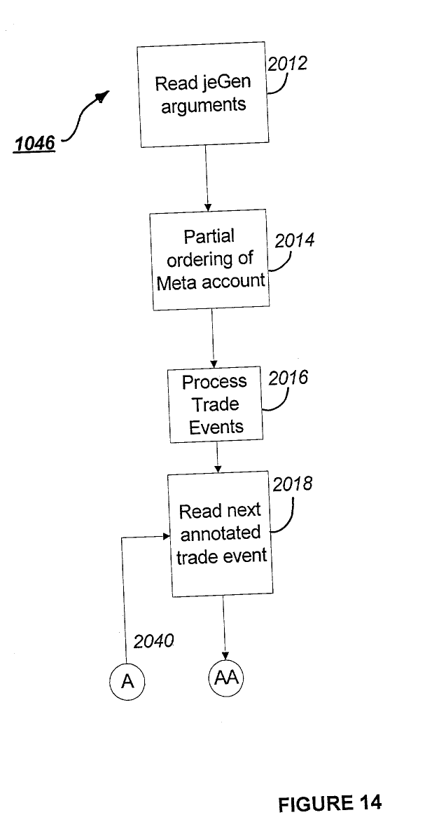

The inventive balance maintenance process uses the annotated trade events generated by the accounting extract, each of which contains a complete set of variable/value pairs, as the core input values from which it builds an accurate accounting representation. A journal entry generation process reads this data and creates journal entries according to pre-defined rule sets contained in the Meta accounts that form the Master account. The journal entry generation process is diagramed in detail in FIGS. 14-17.

The journal entry generation process uses the user-defined rules for subledger balance maintenance maintained in the Meta accounts for the Master account to create the journal entries necessary to maintain the sub-ledger account balances. Journal entry generation processes the annotated trade event transaction and position information generated by the accounting extract, and maintains the balances for the sub-ledger accounts. After the entries are created, they may be posted to the sub-ledger. Balances maintained in the subledger are at the transaction level, a very low level of detail, meaning that one Meta account may generate several journal entries reflecting several annotated trade events for the same instrument, one for each instrument side, each strategy, or one for each trade of the same instrument.

The following example gives an idea of how the journal entry portion of the balance maintenance process works. For this example, we can use the “Swap Interest Payable” subledger account (the balance associated with this account represents the sum of all debit and creditjoumal entries dealing with interest payable on a particular swap position, life-to-date). In accordance with the invention, the journal entry generation process first retrieves the annotated trade event for the pay side of the swap and begins to process the variable/value pair Settled Quantity, which represents the notional amount of the swap at settlement (the date when the initial exchange of any principal, purchase interest, or fees involved is complete), and the variable/value pair Accrued Interest Factor, which represents the percentage of interest that has been accrued to date for the current period but not yet paid, said value being calculated from the end of the previous payment period to the present.

Both of these variable/value pairs are stored in the accounting extract for the effective date being processed. The Meta account rule for the “Swap Interest Payable” account states that balances are to be calculated by multiplying Settled Quantity (a number) by the Accrued Interest Factor (a percentage) to determine the interest payable on the swap. The journal entry generation process does that computation. Next, the journal entry generation process fetches the Sub-ledger detail history and calculates the last balance in the “Swap Interest Payable” account. Finally, the journal entry generation process subtracts the “Swap Interest Payable” previous balance from the product of the Settled Quantity x Accrued Interest Factor, and creates the journal entries needed to adjust the account balance as necessary. The journal entries created are based on the entry style selected, which could be, for example, reversal (entering a reversing journal entry and then entering a journal entry to reflect the new balance) or incremental (entering an incremental journal entry with just the amount to add or subtract in order to reflect the correct balance), which is specified in the Meta account rule for “Swap Interest Payable.” Specifying the style of entry is necessary to ensure that the balance calculated relates correctly to the prior balance in the Swap Interest Payable account.

In accordance with the present invention it is also contemplated that computer calculated journal entries will not necessarily be automatically posted. Users can view the results of the journal entry generation process, if desired, through a viewing mechanism provided by the present invention, or by other means, and then post the journal entries in detailed sub-ledger accounts when they desire. Whether or not a batch of journal entries is posted, it remains in the database table. Batches can be posted, unposted, or they may be handled in other ways as required by the user.

In accordance with the inventive system, journal entry balances for subledger accounts are saved to batch files that can be posted as desired into the database table that holds the history of posted journal entries. The posted journal entries are valid as of the effective date. When an internal account posts its first balances, the accounts involved will have no prior balances or journal entries, and thus will inherently display zero as prior balances in those accounts. Because the initial balances a subledger account are the first ones entered, there is no basis for comparing the journal entry balances generated as of the current effective date with prior balances. Thus, the journal entry balances generated as of the current effective date will be entered as balances in the subledger accounts subject only to the Meta account rules.

Accounts that display prior balances resulting from journal entries posted in the time span between the trade date (the date on which the instrument position was first acquired) and the effective date of the accounting extract being processed will be understood to be seasoned accounts. Such account balances are thus, other than null in value. In the case of a seasoned account, new journal entry balances generated as of the current effective date will be compared with prior balances, and any differences between their balances will be used to generate the journal entries needed to update the account balances in accordance with the Meta account rules, as discussed above. A journal entry balance that has been generated as of the current effective date to which the Meta account rules have been applied will be understood to be an annotated update.

Meta Account Rule Validation

To improve usefulness and efficiency, the present invention provides an optional rule evaluation subroutine that the user may employ to evaluate a rule script entered for a Meta account rule in the inventive system. This ensures that scripting errors will be detected at the time a rule is written, before the rule is employed by an actual journal entry generation process. If a proposed rule script does not work because of scripting errors or other reasons, the user will be given a failure message with the reason for the failure, and the place in the script where the error occurred. In the validation process, the user runs a temporary accounting extract, so that every item of data for trades, instruments, counterparties, allocations, strategies and user defined tags are made available to the rule evaluation process. Temporary journal entries are generated to ensure that the rule will work throughout the journal entry generation process. FIG. 10 shows the location of button 78, which a user may activate to initiate the validation process.

Accessors and Functions

As alluded to above, instrument and trade information, information in the variable/value pairs, and balance information created during the balance maintenance process may be linked to data access methods called “accessors.” In the present invention, an accessor is a method of retrieving a specific data, and accessors may be used in the scripts written for Meta account rules. For example, an accessor arbitrarily named axpNPV may be given the function of retrieving the net present value of a specific annotated trade event from the accounting extract using the above public domain scripting language, or other suitable means.

In the present invention, a function is a low level programming routine that produces, through the operation of the above referenced public domain scripting language, a desired result, such as calculating a sum of two position elements retrieved by their accessors. Function capabilities specific to the present invention are used in Meta account rule scripts and second pass scripts to execute the activities required to maintain balances and other tasks. Functions have “arguments” that are specified in the script. Arguments may be accessors, subledger account names, dates, filenames, batch numbers, or various factors employed by the system, in conjunction with functions, to retrieve data that may be in the form of a valuable/value pair or in the form of a journal entry or other form, or they may be employed to create structures in which to hold specific calculated or generated results. For example, a function statement “makeBatch 1334” contains the function “makebatch” and its argument “1334,” which instructs the inventive process to create a batch file numbered 1334, for receiving journal entries. Another function and argument may be “fetchbalance Pending:Accrued Interest,” which could instruct the inventive process to retrieve the balance of the pending accrued interest account.

Accessors and functions can be combined logically to create scripts that retrieve data, perform calculations on it, and then use the results to generate journal entries for the accounts specified. In the present invention, scripts employing accessors and functions are written in a scripting language, as described above, that is available to the public and that does not require the ability to write programming code.

Meta account rule scripts use accessors to fetch specific variable/value pairs associated with a trade event. The accessors that reflect the details of a trade event do so at a more granular level than trade level but are fully linked to a specific trade. When processing a trade event in the journal entry generation process, all the associated position variable/value pairs generated by the accounting extract are made available to the process via accessors. Saving the variable/value pairs persistently in the accounting extract enables this. When journal entry generation processes an annotated trade event, the required variable/value pairs for that annotated trade event are retrieved so that the Meta account rule scripts can reference any of the variable/value pairs needed.

In the example used above to describe how journal entry generation works, the Master account has a Meta account that references the “SwapInterest:Payable” account. That Meta account contains a rule script stating that the balance maintained in the Swaplnterest:Payable account must equal the product of the accessors axtSettledQuantity, for the settled quantity of the trade, and axtAccruedInterestFactor, for the accrued interest factor associated with the trade, for the current coupon period as of the effective date. The offset rule states that any offsetting entry resulting from this process is to be posted to the “Swaplnterest:Expense” account. To generate the correct balances for the primary account and the offset account, journal entry generation uses the accessors axtSettledQuantity and axtAccruedInterestFactor to retrieve these accounting variable/value pairs from the accounting extract for the specific annotated trading event. Thus, accessors and functions are available for any scripting used during execution of the inventive accounting methodology.

Second Pass Processing

Another component of the present invention is an optional process referred to herein as “second pass processing.” In the present invention, second pass processing allows for particularly convenient and efficient secondary journal entry generation because all journal entry generation done by the second pass process is based on balances in existing posted journal entries, rather than generating journal entries based on annotated trade events. Second pass processing makes it possible to look at a subledger account's posted journal entries from different perspectives, including, for example, by strategy, by pay side or receive side, by dealer, or other indicial criteria as specified in the second pass script.

One of the primary values of the second pass processing of the present invention is that it enables a firm to adjust its Income statement to reflect only the ineffective portions of its hedging trades. This capability is important because newly introduced accounting regulations, for example FAS 133 and IAS 39, discussed previously, require that derivative instruments used to hedge strategies must be accounted for in a firm's books and records, must be marked to market, and the extent to which a hedging instrument is ineffective (defined by the above accounting regulations as being less than 80% or greater than 120% of the value of the instrument being hedged) must be reported in the income statement of the firm. If the accounting system a firm uses to account for traded positions is incapable of separating effective portions of a hedged trade from a hedging trade, the entire portion of the hedging position that does not equal the hedged position must be reported in Income, which in some cases could cause wild swings to the values reported in the Income statement. Second pass processing enables the possibility of adjusting a single subledger account balance, and to transfer balances from one subledger account to another, and many other actions not possible from a standard balance maintenance process.

### Brief Description of the Drawings

Description of the Drawings

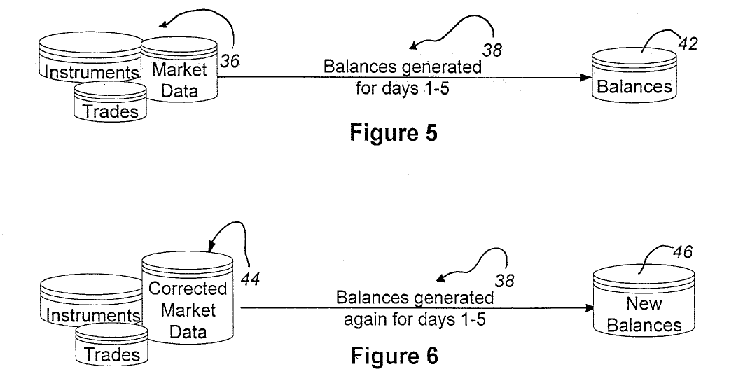

Referring to FIGS. 1-6, the illustrated diagrams compare, at a high level, the current state of the art for subledger balance maintenance systems and the present invention, showing core differences between the two processes. FIGS. 1-4 show the current state of the art relating to the practice of generating journal entries and subledger balances, and how changes to historic data that affect subledger balances are handled. FIGS. 5 and 6 show how the present invention handles changes to historic data that affect subledger balances. As is apparent from FIGS. 1-4, journal entry generation systems must be run every day to capture trade events as they occur, and then generate journal entries daily to reflect the activity.

Referring, in particular, to FIG. 1, in accordance with prior art processing technique 10, we consider a scenario where completed or pending daily trade-related transaction data 12 is imported to the event-driven daily journal entry generation system 14. FIG. 1 shows that the journal entry generation system 14 has created journal entries for five days. The entries are saved by the journal entry system 14 and on a specific date determined by the firm, shown in FIG. 1 as occurring on Day 5, the entries are exported to a balance maintenance system 16, which maintains the firm's subledger accounts in its database of subledger balances 18 relating to trading.

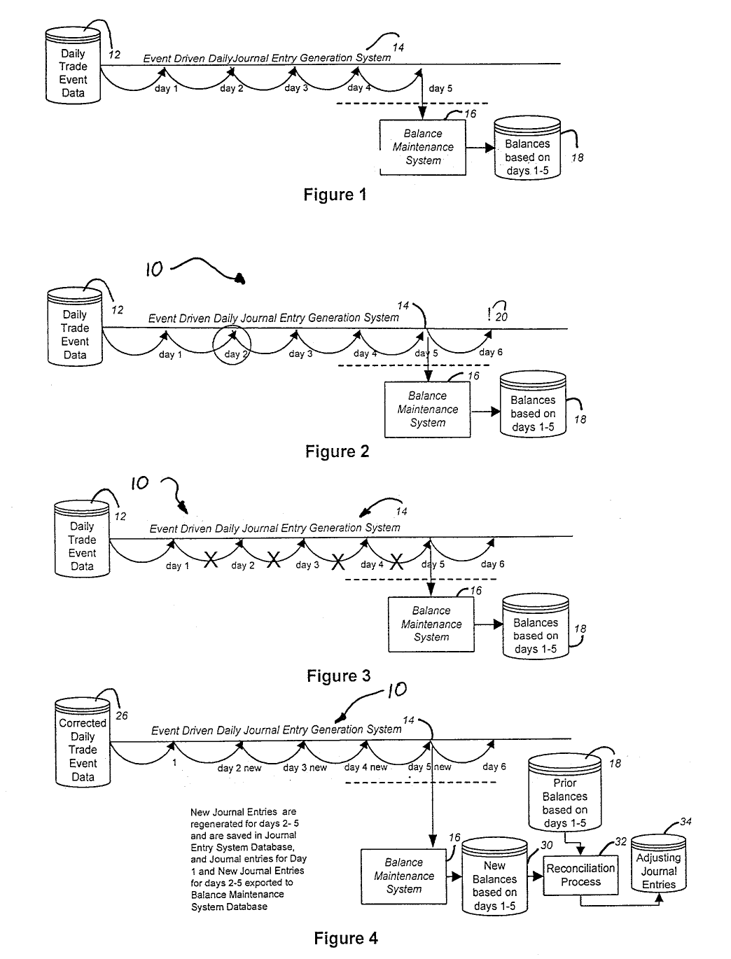

As illustrated in FIG. 2, the system then proceeds to generate more journal entries on Day 6. However, on the sixth day, in accordance with the above illustrative scenario, it is discovered that a correction 20 is needed or a change has to be made to the historic daily trade event data 12 for the second day, Day 2. The corrective action illustrated in FIG. 3 is then required. In particular, error 20 has resulted in making it necessary that all journal entries from Day 2 to Day 5 be deleted as indicated by the x's in FIG. 3. As illustrated in the FIG. 4, the daily trade event data is corrected, and new journal entries are generated for Day 2 through Day 5. These correcting journal entries are then exported to the balance maintenance system 16, where the corrected journal entries are processed and saved as new balances for Days 1-5 in database 30. Next, the prior art balance maintenance system runs a reconciliation process 32 to reconcile the old balances contained in database 18 with the new balances in database 30 and generates the adjusting journal entries and stores them in database 34 to explain the differences. This process can take days to complete if a firm has large numbers of trades, particularly if an error was detected many days after it occurred or if a change to market data was made for a date many days prior to the last balance maintenance processing.

In accordance with the invention, the handling of data is substantially different. Referring to FIG. 5, the inventive balance maintenance system 38 accesses life-to-date data (data from the inception of the trade to the present) from instrument, trade and market database tables 36, and uses this information to generate the balances for days 1-5 and saves them in the database of subledger balances. Because life-to-date data is used to generate balances, the generation of the balance for Day 2 is independent of the generation of the balance for Day 1. Accordingly, mistakes made on Day 1 do not affect the balances generated for days 2 through 5. On the sixth day, if it is discovered that a correction (which changes current balances) is needed or a change must be made to the historic daily trade event data in database 36, the life-to-date data is corrected 44, as shown in FIG. 6, and the balances are regenerated and stored in the journal entry database 46, with the necessary adjusting journal entries. Thus, the inventive balance maintenance system 38 generates new balances for Days 1-5 and stores them in database 46. Here again, because life-to-date data is used to generate balances, the generation of the balance for Day 2 is independent of the generation of the balance for Day 1. Thus, mistakes made on Day 1, once corrected, do not affect the balances generated for Days 2 through 5. It should be noted that the present invention maintains a full audit trail of changes to any element used in the balance maintenance process, such as market data, trade data, instrument data, allocation data, and strategy data.

The illustrations in FIGS. 5 and 6 show that in accordance with the present invention, there is no need to create and maintain daily journal entries, nor to export them to a separate database for balance maintenance processing. If a correction to the historic data that was used to generate journal entries is required, the present invention allows users to correct the data and regenerate the account balances, without having to delete the affected journal entries and then regenerate them from the date the change was required to the date it was implemented. In the event that historic data is changed, the present invention does not require a separate reconciliation process, because, in effect, reconciliation of new balances with prior balances is performed each time the inventive process is employed for balance maintenance purposes.

Referring to the FIG. 7, a graphical user interface 48 provided in accordance with the inventive system is illustrated. Graphical user interface 48 provides for entering the arguments needed by the Accounting extract process to specify at position 50 the internal account, the mark thread at position 52, the effective date at position 54, the functional currency at position 56, and a particular instrument at position 57.

Referring to FIG. 8, there is illustrated a sample portion of an accounting extract report 58 generated by the inventive system, showing some of the variable/value pairs that result from accounting extract process. These pairs consist of variables 60 and values 62, which are given with respect to particular instruments 66. In accordance with the invention, an instrument identification 66, which is here referred to as the “Valuable ID,” is associated with each variable/value pair 62/66 in every annotated trade event relating to that instrument.

Referring to FIG. 9, there is illustrated an example of the graphical display that the present invention provides to show which Meta accounts are contained in a Master account. Clicking on a selected Meta account 68 in FIG. 9 causes the graphical display 70 shown in FIG. 10 to appear.

As is illustrated in FIG. 10, the exemplary graphical display 70, provided in accordance with the present invention, allows an operator to configure which information will be output by the system as a result of the operation of the configured Meta account. Graphical display 70 shows a configuration that could be used to generate the journal entries required to manage an account shown in the figure as the Pending:Accrued Interest account. As discussed above, Meta accounts define the rules that govern the accounting procedures and are a function of a firm's accounting practices regarding instruments in the firm's portfolio. Thus, the Meta Account may be viewed as one of the rules found in the example Master account shown in FIG. 9. FIG. 9 includes a short indication 72 of a mathematical formula governing the operations of the Meta account. A full version of the formula is indicated by reference 74 in FIG. 10, while reference 76 indicates the same formula in the functional currency of the Master Account. Screen 70 also includes identification of the Meta Account, its parent Meta Account, an acronym if the user wishes to associate the same with the Meta Account, a short description of the account, a long description and an indication of the accounting method, the journal entry style. Other features, not associated with the invention, may be included in this screen. In addition, in accordance with the invention, the system includes a validate button 78, which is used to validate a particular Meta account rule such as that illustrated at position 74 or position 76. As will be discussed in detail below, the screen provides a means of entering into the system the information needed for the processing that the present invention employs in connection with the Meta account as described below in connection with FIGS. 14 through 18.

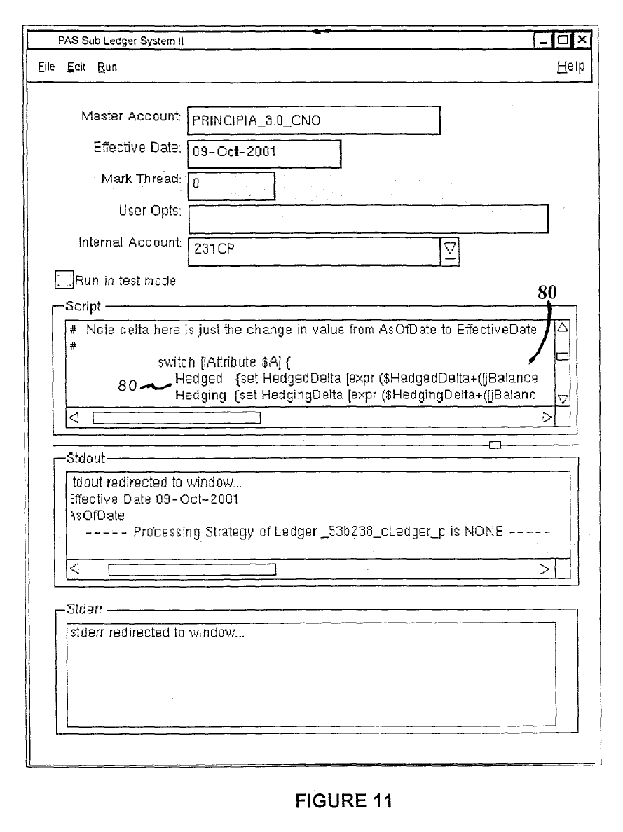

FIG. 11 illustrates an example of a graphical display provided in accordance with the present invention for configuring the information required to initiate second pass processing. The example shows the fields users can use to enter the arguments Master Account, Effective Date, Mark Thread, User Option, and Internal Account, and shows a portion of an example script 80 that the second pass process could use.

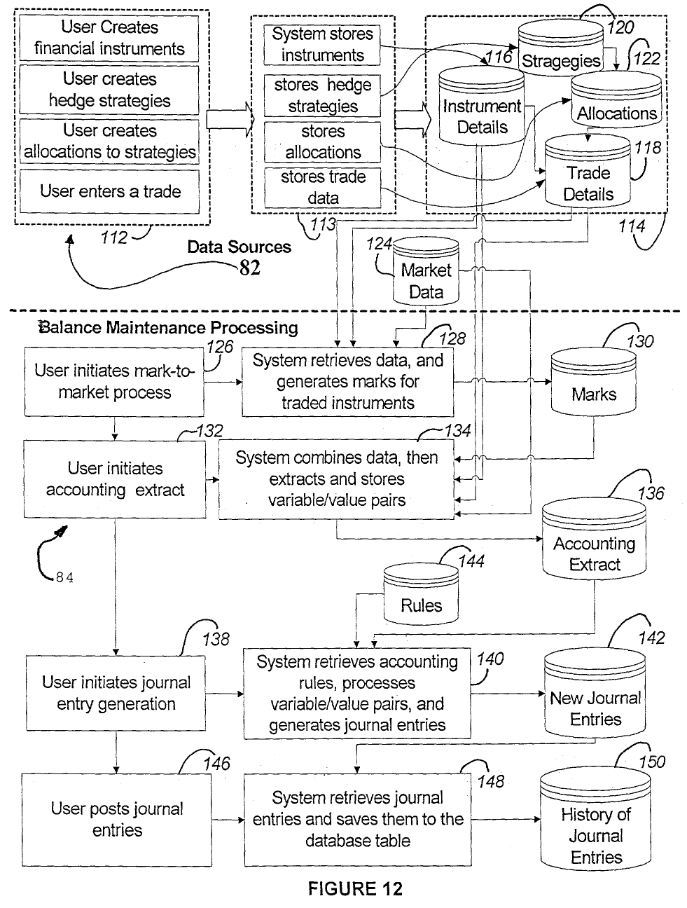

FIG. 12 is divided into two sections. The top section 82 shows how data used by the inventive process is obtained. The bottom section 84 shows the process of maintaining the balances. In the top section of the diagram, users, who may be executives responsible for trading or persons reporting to them, of the inventive system create at step 112 the financial instrument data and related data needed by the system in preparation for trading, that is, for example, the making of the particular trade with respect to which information is being entered into the system at step 112. Such information includes creating financial instrument data, entering hedge strategies in preparation for trading, allocations of hedge strategies, entering information on the particular trade, and linking it, if desired, to an allocation of one or more strategies.

As alluded to above, the creation of hedge strategies relates to the process by which a firm or organization assesses potential risk exposures of the financial instruments in their portfolio, and creates a strategy that involves entering into one or more financial contracts with other entities, whether they are private or governmental entities, to ameliorate the risk of one or more of the instruments in their portfolio. For example, the user of the system may enter into a financial agreement with terms involving such things as swapping interest rates (for example a fixed interest rate for a variable one), or any of the numerous types of transactions routinely engaged in by entities in the financial industry and other businesses, in order to hedge positions.

Because the users of the inventive system decide upon their hedging strategy and input this information and allocations to the same into the inventive system, this information can be tracked by the system, as may be required by the user. As discussed above, the user may allocate all or part of a trade to a strategy. Allocation of a particular trade to various strategies is required when, for example, a particular trade is meant to hedge more than one investment being held by the user. Of course, all of a particular trade can be allocated to a single strategy. Examples of strategies may be hedging exposure to a foreign exchange rate, hedging exposure to interest rate changes, hedging exposure to credit risks, and the like as are routinely created by financial professionals.

Trade data includes the name of the instrument being traded, the names of the two parties involved in the trade, the trade date, the settlement date, the quantity of the trade, the price, and any other core and ancillary information related to the instrument. The processes of creating this information are grouped in FIG. 12, using for convenience one reference number 112. The inventive system at step 113 saves financial instrument data, trade-specific data, strategy data, and allocation data in separate database tables 114 on the inventive system. The processes of the inventive system saving the four sets of data and the resulting database tables are grouped in this diagram using for convenience two reference numbers 113 and 114, respectively. When a user enters a trade in the inventive system, information as to which instrument is being traded and any allocation to strategies is recorded. Instrument data 116 and trade data 118 are cross-referenced by means of unique instrument identification names and trade ID numbers. The instrument identification names and the characteristics of those instruments are either created by the user, or may be identification names and properties used by convention in the financial community, such as, for example, the CUSIP number and characteristics of a municipal bond or treasury bill, or may originate from any sources such that the instrument's name and characteristics can be input by any means to the database and used by the present invention as an instrument. The unique trade event identification numbers and the characteristics of those trades may be generated within the system automatically, or may originate from other sources such that they can be input by any means to the database and can be used by the present invention as a trade of an instrument existing in the instrument database table.

In connection when the entering of a trade into the inventive system, it has been noted above that the instrument being traded also has name and its terms entered into the system in database table 116, separate from the trade details. In accordance with the invention, it is contemplated that an instrument involved in a previous trade may be recalled by name from memory and used again in another trade. Thus, a single instrument can be traded once, or many times, as is needed. Trade data 118 includes the trade event number, the name of the instrument being traded, all trade-specific information, and any links associating a trade with an allocation to a strategy or strategies for hedging. Allocation data 122 and strategy data 120 are held in separate database tables on the inventive system's database. An allocation is linked to a strategy (or strategies) via a unique strategy name (or names) that are decided upon and entered by the user. An allocation to a strategy is linked to a trade via a unique allocation name, and that name may be included as a link within the trade data 118.

In a manner similar to that in which instrument data is saved, allocations are also available for application to multiple trades, resulting in a great efficiency in the effort required to manage allocations of trades to strategies. In accordance with the invention, the characteristics of a strategy or strategies associated with a particular unique allocation name may be changed, for example as judgment or conditions change, and the change in strategy or strategies will be reflected automatically in all the trades with allocations that link to the changed strategy or strategies. In addition, -the changing of percentages allocated to various strategies under the unique allocation name will result in changing allocations for all trades associated with the particular unique allocation name whose characteristics have been changed. As will be apparent from the description below, the result is also to change the reporting of balances that are affected by trades in the system whose allocations were changed.

When the system user desires to generate subledger accounting information, which may be something that is done at any interval keyed to the need to generate accounting extract information (this could be weekly, monthly, quarterly, yearly, etc., as compared to the daily bookkeeping conventionally associated with position valuation), the user inputs the command at step 126 to the inventive system to initiate the mark-to-market process for a specific effective date and internal account (additional internal accounts can be maintained for portfolio positions that a firm wishes to segregate for any purpose), the inventive system assembles the data in the mark-to-market process 128, using the data pertaining to the current terms of and status of title to financial instruments held in that portfolio. Daily market data 124 required for the mark-to-market process 128 is held in a database table in the inventive system's database. Each day's market data is held indefinitely, and becomes part of the history of daily marks maintained by the present invention. This daily market data 124 can be sourced from service providers or generated by users of the inventive system. In the present invention, errors and omissions of daily market data 124 can be corrected at any point in time because daily market data is persistently maintained in the database table for that purpose, as well as for generating life-to-date values of periodic transaction events whose values are dependent on market rates or user input pricing information.

The mark-to-market process 128 calculates prices, or “marks” for the traded instruments in a portfolio for a given date and a given internal account, both of which are specified by the user, and saves the resulting marks to the marks database table 130. The date specified for the mark-to-mark process becomes the effective date for the accounting results that will be generated. The mark-to-market process 128 can be initiated automatically by pre-scheduled automated processing programs or initiated manually by personnel with permission to initiate the process.

Data specific to the daily market rates 124, to the terms of each instrument 116 and to the terms of each trade 118 are sourced from separate database tables on the inventive system. Therefore, if changes have been made to any of the data in these database tables or any data linked to them from the allocations and strategies database tables prior to the time the accounting extract is run, those changes are incorporated into the balance maintenance process without the need for user intervention, underscoring of the advantages of the present invention as compared to the conventional daily record keeping requirements of conventional systems.

After the traded instrument positions have been marked, the system user initiates the accounting extract process at step 132. The accounting extract process initiated at step 132 can be initiated manually by a user of the system or by a scheduled automated process. At step 132, the user specifies internal account, the effective date, and the mark thread. The accounting extract process 134 retrieves the newly calculated marks stored in the database table of marks 130 for each instrument in the portfolio of the internal account specified and combines them with data on the life-to-date history of the terms of each traded instrument's contract details 116 and each trade's details 118, including links to strategy allocation information 122. This combination of data is then processed by the inventive process 134 to yield a set of annotated trade events, each with a set of variable/value pairs 136, which are saved in a data file 136 located on the database server. The variable/value pairs define a wide variety of detailed financial information, including information on the present values of the instruments and information on the life to date totals.

After the accounting extract 134 has been completed, the system user initiates the journal entry generation process at step 138 by specifying the Master account to be used to process the subledger balances. Initiating the journal entry generation process 138 can be done manually or automatically from pre-scheduled automated processing systems. The inventive system retrieves the variable/value pairs 136 saved in the accounting extract data file, and applies the accounting rules found in the Master account data file 144 to processes and generate journal entries 140. In particular, at step 140, the inventive system retrieves the Meta accounts contained in the Master account 144, then processes the variable/value pairs according to the rules in the Meta accounts, and generates and stores the resultant journal entries in a batch file 142.

The accounting rules found in the Master account 144 instruct the journal entry generation process 140 on how to create the first subledger account balances for new trades, how to synchronize any prior subledger account balances with the new balances, and may contain other instructions regarding the creation and disposition of journal entries. The resulting journal entries are saved in a database table, in the form of batches of subledger journal entries 144. After the journal entry generation process 140 is complete, the system user or a previously scheduled automated command can specify the journal entry batches to post, at step 146. At step 148, the inventive system retrieves the subledger journal entry batches 142 specified at step 146, and posts them to the database table that holds the history of posted subledger journal entry batches 150. Regardless of when the journal entries actually are posted to the firm's subledger, the results are valid as of the effective date.

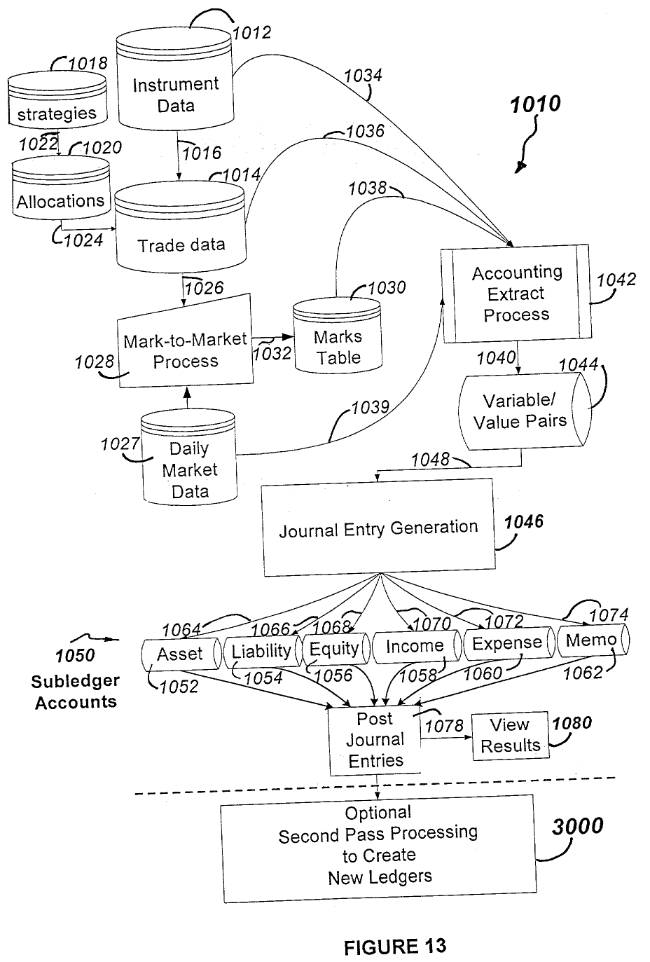

FIG. 13 illustrates, in block diagram form, an embodiment of a subledger balance maintenance processing method 1010, which comprises one of the elements of the inventive accounting system. In particular, when an instrument is created in the inventive system, it is named and its characteristics are saved to a database table. Some characteristics of the instrument may be general to the entire instrument (meaning to both sides in the contract, if there are two sides), and may include, for example, the start date and the maturity date, whether the principal amount will amortize over time, under what conditions options to purchase or sell an underlying instrument may be exercised, etc. Other characteristics may be specific only to a single side of the instrument, and may include, for example, name of the party responsible for paying their side's obligations, the interest rates that one party will pay the other, currency in which the transactions for that side will be paid, any upfront payments due at settlement by either side, the frequency of payments, etc. All data for the instrument, and any changes to the data from the date it has entered the system to the present, is saved in database table 1012 and is linked to trade database table 1014 by path 1016. Any changes to the data are noted in an audit mechanism.

When a trade is entered for a specific instrument, the details of the trade are specified, and may include, for example, name of the instrument, the trade and settle dates, the quantity traded, the price, the buyer and the seller, the dealer (if one was involved), any allocations to strategies, and other information specific to the trade. All of the trade details from the date it was entered to the current date are saved in database table 1014, and any changes to the data are noted in an audit mechanism. The trade data links to financial instrument data and to allocations to various hedging strategies by use of their unique names.

Any strategy allocation is linked to the trade at the time the trade is entered. Path 1022 provides a means for linking of selected strategies that were recorded and preserved previously in database table 1018 with strategy allocation information that was recorded and preserved previously in database table 1020, pertaining to such selected strategies. All data for strategies and allocations are saved from the date they are created to the present, and any changes to the data are noted in an audit mechanism. Path 1024 provides a means for linking allocations of strategies to trade data contained in database table 1014. Information and data pertaining to allocated strategies linked to trades is persistently available to the entire balance maintenance process 1010 by means of paths 1022 and 1024, which provide links to database table 1014.

After trade information has been consolidated in database table 1014 and market data input into the system at step 1027, the mark-to-market process 1028 may be initiated by the user. The mark-to-market process 1028, linked to database tables 1012, 1014 and 1020 by means of paths 1016, 1026, and 1024, respectively, marks all instruments traded for a specified internal account with a price as of a selected effective date (the present invention allows users to enter an external account, for their own purposes, but the general practice of accounting is to process accounts from an internal account perspective, and so when we specify an account, it will be shown to be the internal account). Mark-to-market process 1028 establishes the present value as of that effective date for each traded instrument position based on market value, or based on user-entered pricing, as of the effective date. The output of the mark-to-market process 1028, referred to as the marks, is recorded and preserved in marks database table 1030, including any interest accrued by a traded instrument from the last payment period to the present, from the perspective of the account entered. At the moment that the mark-to-market process is initiated, any corrections made prior to that moment to rates or prices stored in the historical daily marks database table, or to rates or prices stored in any other marks tables from which the mark-to-market process retrieves pricing data, would automatically be included. The mark-to-market process 1028 may be run for any user-selected effective date for which market or user-entered pricing data exists.

Next, the accounting extract process 1042 is run for a specific internal account. The accounting extract process 1042 is linked to the marks database table 1030 by means ofpath 1038.

Accounting extract process 1042 can be run for any effective date for which the user wishes to create journal entries, provided marks for the positions held by internal account specified were previously generated for said effective date. Accounting extract process 1042 polls, for the effective date, the details of the instruments from database table 1012, the current marks from database table 1030, the related market rates and pricing data saved daily in Daily Market Data table 1027, and the trade data from database table 1014, and extracts all position and transaction-related information from the inception of a trade to the effective date, said effective date being required by the inventive system to be the same date for which the mark-to-market was run. When accounting extract process 1042 is run, an inception-to-date picture of all the transactions that pertain to a traded instrument is created. In other words, an accounting of the total interest paid to date for a floating rate bond, for example, whose interest accrues relative to the rate of a financial index, such as the S&P 500, would be calculated, not for the single day for which accounting extract 1042 was actually run, but for the life of the trade since its inception to the effective date specified.

Accounting extract process 1042 takes the position and transaction-related information gathered and calculated from the data sources described above and, from that information, generates variable/value pairs. Variable/value pairs define all the transactions related to a trade, broken down to their smallest components, relating to, for example, pay and receive obligations from the perspective of internal account, current percentages of principal paid, among many other possible elements. Upon completion of the accounting extract, the transaction variable/value pairs are stored in the accounting extract file, which is located in database table 1044. The accounting extract file in database table 1044 is linked to accounting extract process 1042 by means of path 1040. Accounting extract file in database table 1044 is the source of the variable/value pair information that is later polled, in accordance with the present invention, by journal entry generation process 1046, which uses the variable/value pairs to create the journal entries that are used to maintain the balances.

In accordance with the invention, at this point in the balance maintenance process, the user or the scheduled automated command initiating processing specifies the Master account to be employed by the remaining processes. The user specifies the Master account from within a graphical user interface (GUI), whereas the scheduled automated command specifies the name of the Master account in the command line. As alluded to above, each Master account contains a set of rules, each of which the present invention calls a “Meta account.” Each Meta account has rules specifying how journal entries are to be created and how subledger balances are to be maintained. Next, journal entry generation process 1046 polls variable/value pairs from the accounting extract file in database table 1044 and, in accordance with rules contained in the Meta accounts, the journal entry generation process 1046 generates the nominal, or working, balances.

Next, the inventive system compares the nominal balances generated as of the specified effective date with the historic balances for the accounts in subledger 1050 and, in accordance with Meta account rules, updates to the accounts in subledger 1050 are performed, and the journal entries to account for the update to the account balances are generated. The annotated updated accounts, created by the journal entry generation process, are then saved in batches ready to be posted to subledger 1050, and these batches are then labeled as posted at steps 1064 through 1074 to the appropriate accounts 1052 through 1062 in subledger 1050. Subledger 1050 may include, for example, six categories, or types, of accounts as illustrated in FIG. 13. In the illustrated example, the account types included in subledger 1050 are asset accounts 1052, liability accounts 1054, equity accounts 1056, income accounts 1058, expense accounts 1060 and memo accounts 1062. Journal entries for the account types in subledger 1050 may be put through the posting process 1078 or simply viewed at step 1080. It is noted that both posted and unposted entries can be viewed as desired at step 1080 through a viewing mechanism provided in accordance with the present invention, or subledger balances can be exported to other systems external to the present invention by means of other data export mechanisms.

After the subledger journal entries have been posted, the primary subledger balance maintenance process is complete. However, the invention makes possible further highly efficient processing of posted journal entries, if the same is desired, and such optional second pass processing method can be employed, for example, to achieve compliance with accounting regulations, as referred to above.

After the subledger journal entries have been posted, the organization of the processed balance information in posted journal entries makes possible particularly efficient “second pass” processing 3000, as may be required or desired for numerous purposes. In the present invention, second pass processing 3000 is an optional process that supports rules-based scripted processing to generate or modify balances using posted journal entry batches. Second pass processing can examine posted journal entries for individual subledger accounts and, based on the scripted processing, a ledger can be created with new journal entries for managing subledger account balances in ways not possible from the primary subledger balance maintenance processing. In accordance with the present invention, second pass processing to bring reporting into compliance with regulatory and professional standards is among the possible options that may be efficiently implemented.

Details of the Journal Entry Generation Process

An example of a journal entry generation system and method in accordance with the present invention is illustrated in block diagram form in FIGS. 14-17. The journal entry generation process portion 1046 can begin only after the accounting extract process 1042, included in the illustration in FIG. 13, has been completed. In other words, the journal entry generation process 1046 begins only after the accounting extract has broken down all the position and transaction data into variable/value pairs, one complete set for each annotated trade event of an instrument, which are required to facilitate the generation of journal entries needed to maintain balances. In accordance with the invention's accounting extract process 1042, each variable/value pair in the set may be linked to a strategy associated with the annotated trade event being processed. Prior to initiating the journal entry generation process, the user or automated command system will have specified the Master account, whose Meta account rules will be used to process subledger balances.

The first step shown in this detailed diagram of the journal entry generation process encompasses identifying the internal account whose trades will be processed, the mark thread ID, the effective date, and the functional currency. In accordance with the present invention, these identification elements, or “arguments,” which pertain to the processing that follows maybe referred to as “ACCT”, (the internal account from whose perspective the balances will be maintained), “THREAD”, (the number of the column in the marks table associated with the accounting extract data), “DATE”, (the same effective date for which the accounting extract was run), and “FUNCTIONAL CCY”, (the currency in which functional balances will be computed if a functional rule is specified in a Meta account). The journal generation process may be initiated by the user via a graphical user interface (GUI) presented on the monitor of the computer system that is connected by any method to the present invention. The operator using a computer program connected to the inventive method uses the graphical user interface to specify the values for the above arguments. Alternatively, as noted above, the process may be initiated via an automated scheduled computer command that has values for these arguments specified in the command line.

At the same time, any conditional parameters are specified either manually, or automatically from the command line, said parameters may include, for example, “Process Only Extracted Valuable” (which causes system to perform calculations only with respect to a particular traded instrument or set of instruments whose names are specified) and “/user/initialization file instructions” (which instructs to the journal entry generation process to retrieve the initialization file specified for this parameter and to apply any additional processing commands contained in the file, such commands that could, for example, contain additional calculation instructions for calculating balances related to certain instrument types).

After the journal entry arguments are read by the inventive system, it begins, at step 2016, the process of calculating the position for each instrument in the portfolio of the internal account specified. It reads the first annotated trade event for the instrument, if one exists, which is determined at step 2020, performs a preliminary ordering 2014 of the Meta accounts contained in the Master account previously specified by the user or by the previously scheduled automated command. As noted above, each Master account contains no fewer than a single Meta account, but may contain as many Meta accounts as may be required to define the desired operations that are to be performed on the portfolio of financial instruments for the internal account specified.

In accordance with the present invention, the process of “ordering” specifies a preliminary order in which account balances for the portfolio are to be processed. Such ordering is required to provide for balance maintenance offsetting logic, as a means of avoiding circular logic (for example, A offsets to B, B offsets to C, C offsets to A) that could result in the performance of an update on a balance upon which an update has already been performed for the same annotated trade event. The preliminary ordering may be based on the offsets specified in the Meta account(s). At this stage of the journal entry generation process, only a preliminary ordering can be performed because some offsets are known for certain when the variable/value pairs are retrieved, which is reached later in the process. In other words, only a partial ordering can be set because dynamic offsets are only known for certain at the transaction level. Herein, the terms “offset” or “offset account” are used in the conventional sense in accounting parlance, that is, an account balance that is updated as a result of a change in the balance of the account currently being processed.

After the preliminary ordering of the Meta accounts is complete, processing of the variable/value pairs begins at step 2016, where the nominal balance calculation process begins. This is achieved in the following manner.

At step 2016, an intermediate structure, referred to in the present invention's description herein as “cLedgerBalance” is constructed in preparation for receiving the nominal balances created for each instrument referenced in the accounting extract. cLedgerBalance is a programmed structure that acts as a staging area for accumulating and recalculating balances as the system applies the rules contained in the Meta accounts. Each journal entry created is based on Master account/Meta account indicial attribute criteria. These are the criteria that must be assembled first when evaluating the information brought to the process from the Accounting extract. In accordance with the present invention, the Master account/Meta account indicial attribute criteria will be understood to be “CCY” for the currency involved in the annotated trade event, “account” (in general, this is the internal account) for determining the perspective from which the journal entries will be generated, “side” specifying what the internal account must pay or receive, “strategy” for the strategy associated with the annotated trade event, “attribute” for determining if the trade has been hedged or is hedging, “dealer” for any agent who acted as an intermediary between the two counterparties on the trade, and “trade ID” for the identification number of the trade.

After cLedgerBalance is created, the present invention begins polling the annotated trading events at step 2018 from the accounting extract to be evaluated. Steps 2018 through 2026 describe the processing required to determine the final order of the Meta accounts needed to process the instrument position. The inventive process examines the accounting extract information, which is organized by instrument name in alphabet order. For each instrument name, the annotated trade events are presented in trade identification number order. For each bilateral (two sided) trade there is an annotated trade event for each leg of the instrument, reflecting the pay and receive obligations of the internal account. For each leg of the instrument, any percentages allocated to multiple strategies are broken out, and there is one annotated trade event for each strategy. After fetching the first annotated trading event, which constitutes the first annotated trade event for an instrument, the system determines if there are variable/value pairs to evaluate 2020, and if so, moves on to examine the first (or the next) annotated trading event 2022. At that point, any offsets for balances to be generated for the first annotated event are known, and so the order of the Meta accounts is reorganized based on the offsets. Any succeeding annotated trade events will cause a further reordering of the Meta accounts. The number of annotated trade events relating to an instrument is determined by whether the instrument is bilateral (has pay and receive obligations), or its trade has allocations to more than one strategy, or it was traded more than once. For example, if an instrument has been traded only once, and it has only a receive side, and there is no allocation to multiple strategies, then there is only one annotated event for that instrument. If, on the other hand, for example, an instrument has been traded more than once, whether it is bought or sold, there will be an annotated event for each trade involving that instrument. Therefore, in the accounting extract, there might be observed a single annotated trade event of, for example, an instrument arbitrarily named “Swap-5-11-2001,” followed by three annotated trade events of the instrument T65NOV26, a Treasury bill that matures in 2026 and pays 6.5% annually, specific quantities of which the internal account has either bought or sold in three trades.

By way of example of variable/value pairs, if, for example, the internal account has purchased a bond, which required an initial payment of principal upon settlement, as is the case for bonds, the principal payment is noted in one of the variable/value pairs contained in the annotated trading event. If any payment of interest on that same bond has been received after the trade settled, the interest payment constitutes another variable/value pair in the annotated trading event for that bond. If a variable/value pair has zero as its value in the annotated trade event information, no entry is created in cLegerBalance for accounts related to that element. For example, if there was no principal exchanged at the settlement of a trade for a specific instrument, no entry is created in cLedgerBalance for any account related to principal exchanged at settlement for that annotated trade event.

The polling of step 2018 of the accounting extract file, containing annotated trading events as discussed above, is continued until such time as there remain no more annotated trading events that require processing.

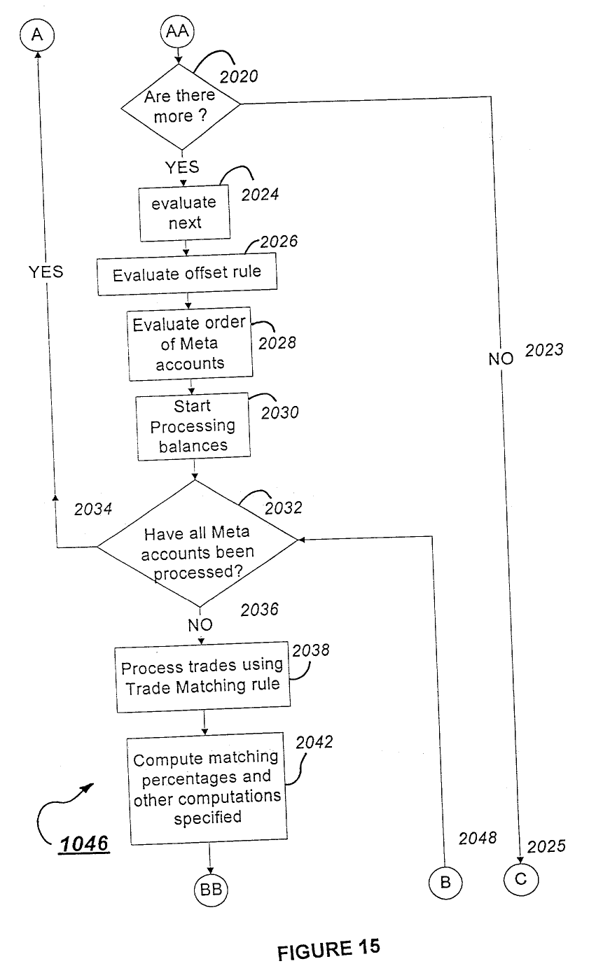

FIGS. 14 through 18 constitute what may be a continuous process. The drawings are graphically linked to each other by means of “balloons” that are giving lenders to indicate that they are common points linking the diagrams of these figures together. For example, balloon A in FIG. 14 represents a common path from balloon A in FIG. 15, and balloon AA in FIG. 14 represents a common path to balloon AA in FIG. 15. The balloons thus serve as a convenient graphical device for directing how the figures connect with each other.

Referring to FIG. 15, at the start of the process of reading the annotated trade events, as shown in step 2018, of FIG. 14, the inventive accounting system contains a step 2020 which is a return point for determining whether there are any annotated events that have not yet been processed for the particular accounting extract. If the answer to query “Are there more annotated trade events to evaluate?” at step 2020 is “NO”, as it would be if all the annotated events for an instrument were processed, the inventive system proceeds to “housekeeping” on nominal balances in cLedgerBalances. “Housekeeping” refers to the collapsing of multiple positions of a single instrument so that the final result is one journal entry that explains the account balance update for that instrument. If the answer to the query at step 2020 is “YES”, indicating that there are one or more annotated trade events to evaluate, the inventive accounting system proceeds to process the first or next annotated trade events at step 2024 in accordance with the applicable current Meta account rule or rules applicable.

Next, the inventive system performs evaluation step 2026, and determines the final order of the Meta accounts. At this point, because any Offset account balances that could be generated are now identified and evaluated relative to the Meta accounts, as discussed above, said Meta accounts can be put into their final order. What is looked for in this evaluation is any illogical or circular logic of updating an account balance that references itself through an offset somewhere in the chain of accounts referenced. At the conclusion of the full ordering, there are no computed balances yet. It will be understood that the Meta account specifies the offset rules for the annotated trading event that is being processed. Based on the outcome of that evaluation at step 2026, the Meta accounts are, at step 2028, put into their final order for processing the current annotated event.

When the ordering process in step 2028 is complete, the inventive system begins to process the current annotated trade event, at step 2030 using the fully ordered Meta accounts to create balances for the instrument. Step 2032 is a return point for determining whether there are any Meta accounts that have not yet been processed for the current annotated trade event. If the answer to query “Have all Meta accounts been processed for this annotated trade event?” at step 2032 is “NO”, as it would be if none of the Meta accounts have been processed for the current annotated trade event, the inventive system proceeds to process the first or next Meta account at step 2038 in order to generate the balances for which it is responsible. If the answer to the query at step 2020 is “YES”, all Meta accounts have been processed for the current annotated trade events, the process returns to step 2018 in FIG. 14, and reads the next annotated trade event.

The programmed structure cLedgerBalance, described above, represents the universe within which any required trade matching will occur for that instrument. Said cLedgerBalance does this by setting up an area in step 2038 to manage any trade matching parameters specified in the Meta account being processed. Meta accounts may specify different types of trade matching. By “global trade matching”, it is meant that elements of annotated trade events involving multiple trades of a single instrument can be assembled to properly manage the position and to calculate additional information based on the comparison of each trade quantity to the previous trade quantity for the same instrument and to the original position bought. For those trade events that require global matching, the inventive system computes at step 2042 matched percent, “MPct”, the percent of the original trade that has been bought out (closed), open percent, “Opct”, the percent of the original trade not yet bought out, or open percent, the match date (the trade date of the closing position). Trade matching for each trade within the grouping for the matching choice specified in the Meta account is made on a first-in, first-out basis (FIFO). FIFO requires that a position held be reduced in the order in which the reducing trades were conducted. Alternatively, trade matching by strategy or by dealer, for example, may provide a means to assemble the elements of an instrument's total position to enable calculation of additional balances for specific purposes, such as total by strategy, total by dealer, or other criteria as specified in the Meta account rules for trade matching.

Trade matching is performed in accordance with certain criteria specified in the Meta account, e.g., globally, by book, or trading account, by dealer, or by strategy, and applies only within the same instrument. For example, a firm may buy a large position in a currency future instrument, then sell off portions of their position in that currency future. The initial buying trade and its selling trades are linked via the instrument name and its trade identification numbers. In order to reduce the original position held, the selling trades must be globally matched with the original buying trade. Trade Matching choices are arbitrary, but in accordance with the preferred embodiment of the present invention are as follows:

Global—takes all trades for the same instrument and performs FIFO matching and then applies the Matched Percent to the trades. (The Open Percent equals [1−Matched Percent]).

By Book—applies the matching process described for “global” within each child account of the internal account selected for the journal entry generation run, if the internal account has child accounts.

By Dealer—applies the matching process described for “global” within each Clearing Broker entered on the trades that are being processed in the journal entry generation run.

By Strategy—calculates the offset for the same instrument within a Strategy.

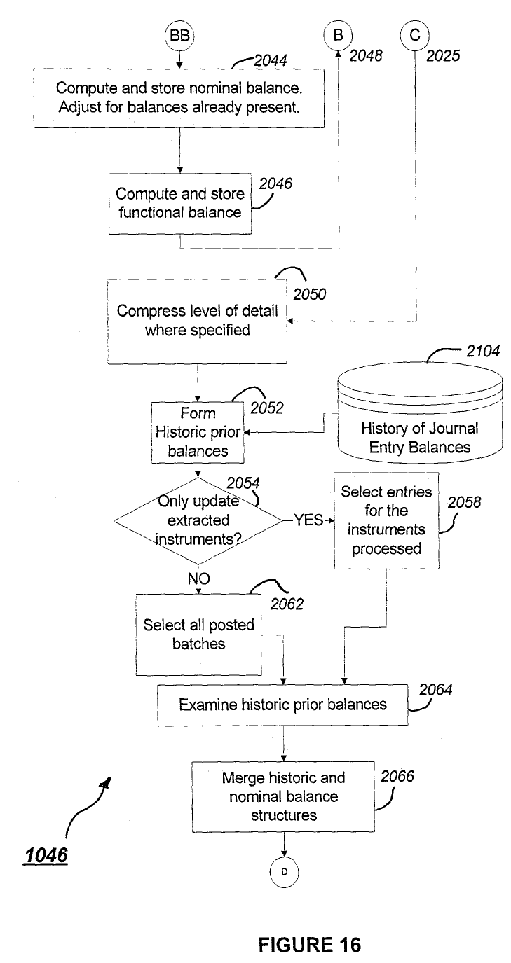

Referring to FIG. 16, the inventive system uses all the information previously assembled and calculated in cLedgerBalance in steps 2024 to 2042, to compute and store, at step 2044, the nominal balance in cLedgerBalance, and adjusts this balance for any balances already present as a result of prior offsets from previous Meta account rules already processed. This process also accumulates any nominal offset account balance in the “prior balance” portion of cLedgerBalance. The result is to accumulate the nominal subledger account balance in cLedgerBalance, and to accumulate the normal offset account balance in the prior balance portion of cLedgerBalance. Having a prior balance portion in cLedgerBalance facilitates efficient control of the offsetting logic and its effect on the nominal balance. This process also forms a separate cLedgerBalance for any non-synchronized subledger account by accumulating its offsets. Non-synchronized accounts may be offset accounts whose balances are accumulated but not synchronized with previous balances by the inventive process. The present invention can generate journal entries to offset accounts, but it does not control the balance of non-synchronized accounts. Generally, these tend to be special purpose accounts and may not be considered necessary to maintain.

Next the inventive system computes and stores at step 2046 the functional balance, using the Meta account's functional rule as a base. As described previously, the functional balance is the nominal balance as computed by the Meta account rule converted to the functional currency. This is done at the spot rate for the effective date. If all Meta accounts for the select annotated trading event have been processed, the inventive system proceeds to process the next annotated trading event.

FIG. 15 and FIG. 16 are linked by means of balloons B, which provides a loop for processing of all Meta accounts associated with a selected annotated trading event. Next, at step 2050 the inventive system compresses the transaction details, at the trade ID (identification) level, on nominal cLedger balances for all Meta accounts in which the user has set the argument “mask trade detail” to “YES” in screen 70 (FIG. 10). Trade masking, which is a conventional processed not at the center of the present invention, consolidates all of the constituent pay and receive, or long and short, positions into a single position for an instrument after the calculations have been performed on the initial buy transaction and the subsequent sell transactions related to a trade. Ancillary transactions, for example, coupon payments, also will be masked and only a final balance will be shown in the specific account. Showing every transaction related to the instrument could involve a large number of debits and credits appearing in a report for accounts for this instrument. Compression technique is available for global matching for buys and sells of the same instrument, matching based upon strategy, by book, or by dealer, all described previously.

Next, at step 2052, the inventive accounting system polls all the journal entry batches posted for the internal account prior to the effective date time stamp, and calculates and constructs the historic balances.

At step 2054, the inventive system queries the argument “only update balances on extracted instruments” as to whether the user set it to “Yes” when initiating the journal entry generation process. If the answer to the query at step 2054 is “YES”, the inventive system will, at step 2058, query all posted summary batches and subsequently posted journal entry batches and then select only those entries related to the instruments extracted. The “arguments” pertaining to the batch selection process include “ACCT”, (the internal account from whose perspective the balances will be maintained), and “THREAD”, (the mark identification associated with the accounting extract data).

If the answer to the query at step 2054 is “NO”, then the inventive system will proceed to update all the balances for the internal account specified. At step 2062 historic balances are selected from all posted summary batches and subsequently posted journal entry batches generated prior to the effective date time stamp, for the same thread and internal account. Summary batches are batches of journal entries that contain a summarization of all subleldger account balances, as of a specified date, said summary batches being generated by an ancillary process available from the present invention. The summarization process compiles all journal entry batches that were posted preceding and including the summarization date. Summary batches increase the efficiency of balance maintenance processing by limiting the number of historical journal entries required to generate historic balances. The “arguments” pertaining to the batch selection process include “ACCT”, (the internal account from whose perspective the balances will be maintained), and “THREAD”, (the mark identification associated with the accounting extract data).

Next, the inventive system proceeds to step 2064, where the historic balances are examined, using the same indicial attribute criteria as was used for the processing for the nominal balances in cLedgerBalance. As described previously, these are currency, internal account, side (pay or receive), strategy, attribute (whether the position is hedged or hedging), dealer, and trade identification number.

The inventive system then merges the historic and the nominal balances at step 2066, using any suitable matching algorithm or algorithms based on the indicial attribute criteria to align them in preparation for processing the final balances for each account.

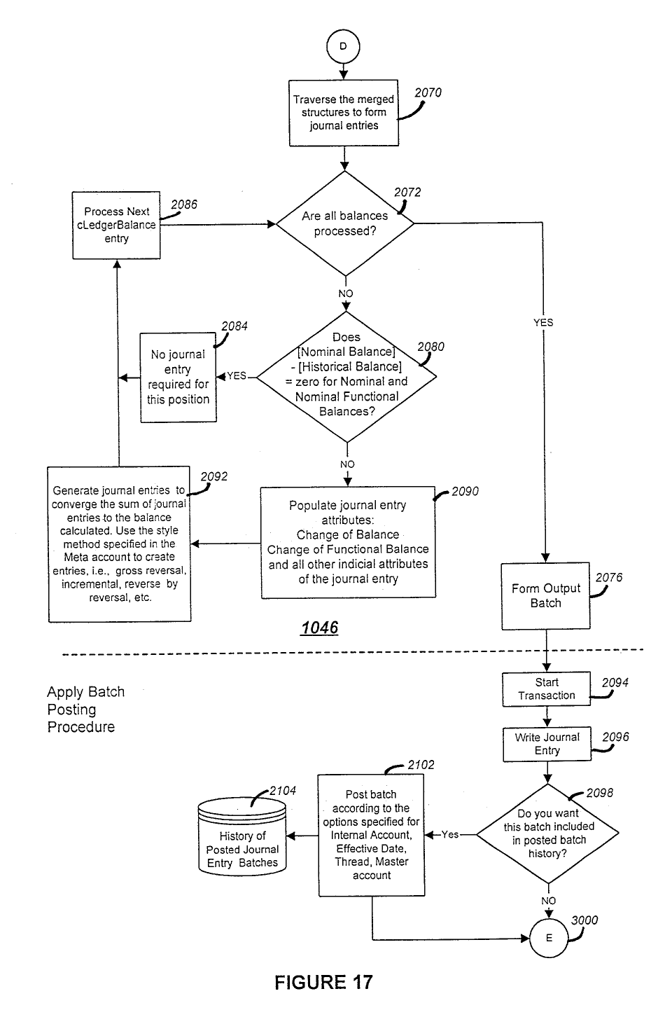

FIG. 16 and FIG. 17 are linked by means of balloon D that provides a path to the next task in the process, at step 2070, the merged historic and nominal balances are traversed to form journal entries.

Referring to FIG. 17, at step 2070 the inventive accounting system traverses, or passes through and examines, the merged historic and nominal balances and processes the first cLedgerBalance entry to create a journal entry described as follows. At step 2072, the inventive accounting system queries as to whether all balances have been processed. If the answer to the query at step 2072 is “YES”, the inventive system forms an output batch at step 2076.

If the answer to query 2072 is “NO”, indicating that there are balances to be processed, then the inventive system at step 2080 queries as to whether the difference between nominal balance minus historical balance equals zero. If the answer to the query at step 2080 is “YES”, the balance equals zero, 0 then the system determines at step 2084 there is no change in the balance and, therefore, no requirement to create a journal entry for the selected balance, and the inventive accounting system proceeds at step 2086 to process the next cLedger balance entry. If the answer to query 2080 is “NO”, then the balance does not equal zero, and the inventive accounting system will generate at step 2090 a set of journal entry attributes will be used as identifying criteria for the journal entries created. In accordance with the inventive accounting system, journal entry attributes will be understood to mean a change of balance, a change of functional balance, and any of the indicial attributes of the journal entry that may be applicable, including currency, internal account, side, strategy, attribute (hedged or hedging), dealer, and trade identification number, and any other information specific to the journal entry.

Next, at step 2092 the inventive accounting system generates the journal entries necessary to converge the sum of those journal entries to the balance calculated. The style method specified in the Meta accounts will dictate the type of journal entries created. Style methods are specified by the user in accordance with the firm's accounting preferences and practices. In accordance with the inventive accounting system, the term “style method” will be understood to mean, reversal, incremental, or reverse-by-reversal. The style method specified in the Meta account determines which journal entries will be produced:

Incremental style entries will post the difference between the total from the previous entries from posted batches and the inception to date balance calculated for the account by the evaluation of the rule in journal entry generation. For example, if the prior balance was a 100 CR (cr means credit) and the new 30 balance is a 120 CR, then a 20 CR entry would be generated.

Reversal style clears out the previous posting entry and then restates fully. For example, if the prior balance was 100 CR and the new balance is 120 CR, selecting the reversal style will generate a 100 DR to reverse out the 100 CR from the prior date, and then generated a 120 CR entry.

Reverse-by-Reversal operates similarly to reversal but instead of producing an offsetting DR (DR means debit) or CR, it generates a negative DR or CR. For example, if the prior balance was 100 CR and the new balance is 120 CR, the reverse-by-reversal style will generate a—100 CR to clear out the original entry and then generate a 120 CR to post the new balance.

Note that the journal entry style method is determined by the style method used for the previously posted journal entries.

The inventive accounting system then proceeds at step 2086 to process the next cLedger balance until all cLedger balances have been processed.

After all the cLedger balance entries are processed, the inventive accounting system processes the journal entry structure required. To accomplish this, at step 2076 the inventive accounting system forms an output batch, at step 2094 begins the transaction of transferring journal entries and at step 2096 writes the journal entry to the batch file, which contains all the information created during the generation process. Each journal entry is labeled with all the indicial criteria used in the generating process.

When no more entries for cLedgerBalance exist, the journal entries saved thus far in a batch can be posted, if desired. The inventive accounting system then queries at step 2098 as to whether the selected batch is to be posted. Posting journal entries saves them to the database table of posted journal entries, where they become available as part of the history of all posted journal entries for an account. If the answer to query 2098 is “NO”, then no more processing is required for the current batch of journal entries, which is simply saved as an unposted batch. If no more processing of the balances is required, the system has completed the journal entry portion of its processing.

If the answer to query 2098 is “YES”, then at step 2102 the inventive accounting system posts the selected batch, labeling it with the processing arguments specified for the selected subledger update, i.e., the effective date, thread, master account, and internal account, to posted batch history table 2104 that is contained in the memory of the computer system.

At the conclusion of the journal entry generation process illustrated in FIGS. 14 through 17, the journal entries are posted to the subledger accounts as desired. Regardless of whether or not they were posted, the balance information contained in the journal entries generated is available for presentation in a form determined by the user.

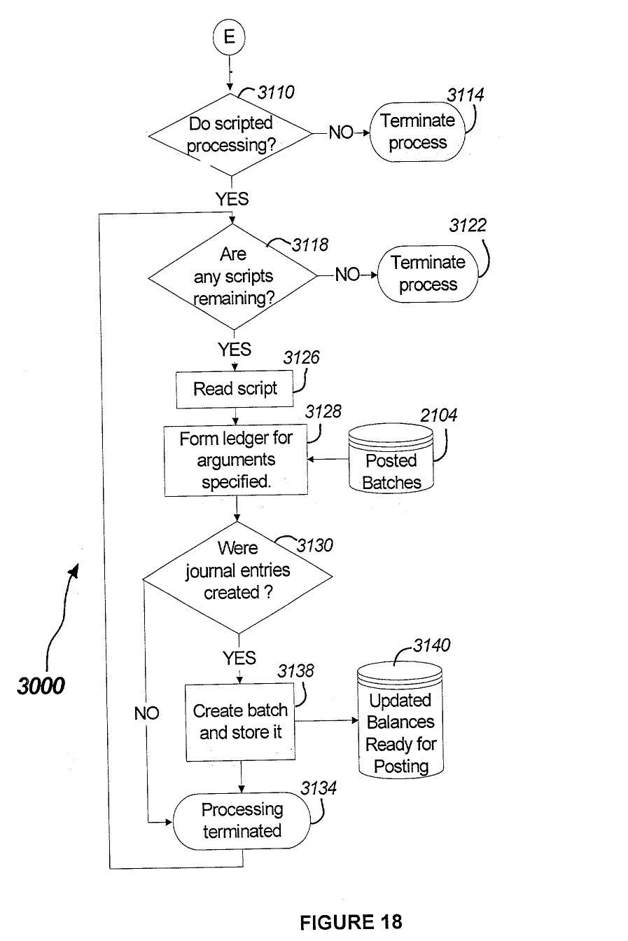

If desired, after the completion of the first pass in the accounting process, culminating in the implementation of the batch posting procedure, additional accounting procedures may be employed. This may include accounting associated with mandatory recording requirements under FAS 133. One such procedure is outlined in block diagram form in FIG. 18.

Details of Second Pass Processing

Advantageously, the inventive process has the ability to efficiently compare the positions of instruments with hedging relationships, calculate the difference between the hedged and hedging position, and if there is any difference, then generate journal entry balances that will reflect only the amount that is required by regulation to be reported in the Income statement, that is, amounts that exceed the 80/120 rule discussed above. In particular, the above second pass processing, as it is referred to in the present invention, provides this capability. The graphical display provided by the inventive system for initiating second pass processing is shown in FIG. 10. Second pass processing is diagramed in FIG. 18 and will be described below. In addition to the ability to assemble posted journal entries and then generate journal entries not possible from standard journal entry processing, the second pass processing provides the ability to assemble posted journal entries and then perform calculations using them, and output the results in report formats specified in user-created command scripts.

In the primary balance maintenance process, if it is conducted in accordance with the present invention described above and referenced in FIGS. 1-17, all of the Meta accounts in a Master account are used to evaluate each annotated trade event passed from the Accounting Extract. An annotated trade event, as it relates to the accounting extract, is the lowest level of detail for a traded position, and each journal entry generated is defined by seven key initial criteria, namely internal account (an identification of the account from whose perspective posted journal entries were generated), currency, dealer (any intermediary who assisted in buying or selling the position to the two parties involved in the deal, but who is not the counterparty to the deal), strategy (fair market value, cash flow, foreign currency, or none applied), allocation attribute (hedged, hedging, none applied), instrument (name of the option, loan, swap or like), and side (pay or receive, from the perspective of the internal account). Second pass processing adds an eighth key criteria, a reference to one or more subledger accounts and this is done for the purpose of specifying which journal entries that are to be pulled in for second pass processing.

More particularly, it is the object of the present invention to use, in addition to one or more of the seven key criteria, the output balances in posted journal entry batches formed during the first pass through the accounting information. Thus, second pass processing is built upon posted batch information.

In second pass processing, journal entries that correspond to any of the above key criteria are selected from posted journal entries by subledger account, which acts as a sort of eighth criteria. By adding this eighth criteria, the subledger account, second pass processing enables users to create a ledger journal containing only journal entries generated for a specific subledger account, and posted in the main subledger, and to calculate new second pass journal entries, where the same are required to comply with accounting standards or are otherwise desired. Suchjoumal entries are generated based on the key criteria, including the subledger account from which the initial entries were taken, the processing functions specified in the script, and the subledger accounts specified in the script to be updated by the new second pass journal entries.

FIG. 17 is linked with FIG. 18 by means of balloon E, which provides a path to query process step 3110. The optional “second pass” processing illustrated in FIG. 18 allows for a second pass through the journal entries generated in the primary subledger processing just described, in order to create new journal entries based on balances in existing journal entries instead of on transactions. To begin the second pass process, the inventive accounting system queries at step 3110 as to whether scripted processing of posted balances is required.

If the answer at the application of the query of step 3110 is “NO”, then the balance maintenance process is terminated at termination step 3114. If the answer to the query at step 3110 is “YES”, then the inventive accounting system proceeds to query step 3118 and determines whether there are any second pass rule scripts remaining to be processed.

If the determination at step 3118 is “NO”, there are no second pass rule scripts to evaluate, then second pass processing is terminated at termination step 3122. If the determination at step 3118 is “YES”, then at step 3126 the inventive accounting system polls the second pass rule script to be processed. The second pass rule script is a scripted set of commands that further instruct the present invention as to which journal entries to retrieve, how to assemble the selected entries into journals, any computations to be done upon the balances associated with those journal entries, and finally how to manage any additional journal entries that are generated as a result of the computations.

The second pass portion of the present invention is organized around two key concepts particular to the present invention: a journal and a ledger. A journal is a collection of debit/credit journal entries for the subledger account specified. In essence, those journals are homogeneous in subledger account, meaning the journal entries they contain were selected from only one subledger account. A ledger may be a collection of these homogeneous journals. Second pass processing can create a ledger of homogeneous journals organized by indicial criteria, and then compare the balances and perform the operations specified. For instance, a journal may be created that contains only the journal entries contained in the subledger account Asset: Net Present Value, having the allocation attribute “Hedging.”

The Second Pass process uses the balances from posted journal entries that correspond to second pass arguments (i.e., certain required data items), those arguments being the Master account, Effective date, the thread, and the internal account. The Second Pass may use a scripted rule to further define which journal entries are assembled, to perform specific processing on the balances associated with the selected journal entries, and to create new journal entries for the ledger account specified. The second pass uses the same script language functions and accessors contained in the subledger balance maintenance system to manage the ledgers and journals it generates, with some additional functions and accessors. The second pass functions and accessors are used to form ledgers and any subledgers desired, journals, batches, and journal entries. In addition, functions can be used to shift the balances of one subledger account to another.

An example of a function that may be executed in a rule script is generating a new set of journal entries, which may be done using the command AddJE. Inserting a balance generated by the second pass process requires a debit and a credit, and so the command must create two entries. The arguments to the AddJE command are Debit, Credit, Amount, Ledger, and Batch (meaning that the first journal entry created is a debit, the second is a credit, the amount (which can be expressed as a mathematical formula to be employed to calculate an amount, or a reference to a previously calculated amount), the name of the ledger to be created, and the batch number to be created to hold the results). This command may be part of a script that passes through the assembled journal entries, performs calculations, then generate the new journal entries using the arguments for the command AddJE. One journal entry will debit the subledger account specified to receive the debit, and the other will credit the subledger account specified to receive the credit. The remaining information for the journal entries will be filled in based on the key criteria in which Ledger is homogenous, meaning that the journal entries produced will be marked as second pass journal entries, and will be labeled with the internal account, the effective date, mark thread, master account and any other criteria that was used to specify and organize the journal entries that were fetched, such as strategy, hedge attribute, etc.

As a further example of AddJE, consider the following command fragment to be implemented as part of a second pass operation:

AddJE Income:CapGain Expense:Ineffectiveness [expr abs($Ineffectiveness)][expr abs($Ineffectiveness)*[spotFX [s1EffectiveDate][1Currency $CCY][acFunctionalCurrency]]] $HedgingLedger $OutPutBatch

The present invention will create a debit journal entry for the Income:CapGain account and a credit journal entry for the Expense:Ineffectiveness account for the ledger $ HedgingLedger, and the two journal entries are to be stored in the batch called $ OutPutBatch. In other words, the invention will generate the journal entries for the subledger accounts specified, for example capital gains, and their balances will be calculated according to a scripted formula. For example, the formula above states that the amount of ineffectiveness is to be expressed in its nominal currency and in the functional currency as calculated from the spot rate for the effective date of the subledger from which the initial values were taken, and the debits and credit journal entries are to be deposited in the ledger specified, for example to place the debit to Income:CapGain into ledger HedgingLedger and the credit to Expense:Ineffectiveness into ledger OutPutBatch.

Journal entries generated by second pass processing will be stored in batches and can be posted in the same manner as the primary journal entry generation batches can be posted.

Returning to the description of FIG. 18, the methodology in which the inventive system achieves of the stated second pass results is illustrated. More particularly, after reading the subledger second pass processing script, at polling step 2104, the inventive accounting system polls the posted batch history database table, and selects journal entries matching the selected second pass arguments, and any additional selection criteria specified in the second pass rule script.

In accordance with the present invention, the second pass arguments will be understood to be Master Account, Effective Date, Thread, and Internal Account, as defined in the previous discussion on the journal entry process. The rules script may further refine the journal entry selection process by specifying, through the use of accessors, described previously in the key concepts section, many other conditions for selection. For example, an accessor may be used to specify which type of instruments will be involved in the journal entries selected. For example, as script may use the accessor, arbitrarily name InstrumentType, to specify that only journal entries related to the instrument type “bonds” will be assembled into ledgers and journals.

When the journal entries have been selected, at step 3128 the present invention forms a ledger, or ledgers, as specified in the second pass rule script. A ledger is formed based on the seven key criteria, one or all of which can be specified in the rule script for the purpose of organizing the ledger as described above. For example, a rule script could instruct the present invention to form the selected subledger journal entries into a ledger with journals that may be organized first by internal account, so that each journal is homogeneous by internal account, then each journal is further organized by strategy, and finally by the attribute (hedged, hedging or none).

After the second pass ledgers and journals have been formed, the additional processing specified in the second pass rule script takes place, including any type of action possible in the public domain script's command structure.

After the second pass rule script's commands have completed their processing, the inventive accounting system queries at step 3130 as to whether there are any second pass journal entries created by the processing script. If the answer to the query at step 3130 is “NO”, then second pass processing is terminated at terminations step 3134 for the second pass rule script being processed. If the answer to the query at step 3130 is “YES”, then journal entries are formed into a batch step 3138 as specified in the script, the entries are labeled as second pass journal entries, and the batch is stored as a second pass batch in updated balance tables 3140. An updated balance table holds journal entries that have not yet been posted but are available to view and to post as desired.

At the conclusion of the second pass process illustrated in FIG. 18, the journal entries are available for presentation in a form as determined by the user. If desired, the same may be posted.

1. An accounting process of the type employing a subledger specific to the particular area of financial portfolio management, wherein the improvement comprises a process such that accounts in said subledgers may be created and maintained by employing user-defined accounting rules associated with each account balance in conjunction with life to date information on the positions in a portfolio, the above accounting rules being referred to as meta accounts, the collection of all meta accounts being referred to as a master account, said process comprising the steps of:
(a) outputting to the user an interface calling for financial instrument terms and related information;
(b) entering into said interface the terms of a financial instrument, such as the start and maturity date, interest rate, payment periods and all other information that may pertain to the particulars of an instrument;
(c) saving said instrument information in a database table specific to instrument data;
(d) outputting to the user an interface calling for trade information;
(e) inputting into said interface the name of an instrument having desired terms corresponding to those that one desires to implement in a particular trade;
(f) entering the trade date associated with said trade;
(g) entering the trade date quantity associated with said trade;
(h) entering the price associated with said trade;
(i) entering a dealer name and any other optional information associated with said trade;
(j) entering an allocation, said allocation being symbolized by an allocation name, such as “deutsche mark hedged” or “deutsche mark hedging”, and said allocation having an attribute of being a hedging or a hedged trade, and a descriptive strategy denominator, such as “deutsche mark currency”, saving said settle date, trade quantity, price, dealer name, allocation and any other optional information comprising trade details;
(k) saving said trade details to a table specific to a trade data in a database, said database storing information respecting a plurality of instruments associated with a particular internal account;
(l) repeating steps a through i for a plurality of trades;
(m) collecting daily market data related to the instruments one may hold or may plan to hold in one's portfolio, said market data saved daily such that a history of daily market data may be maintained in a database table for that purpose:
(n) retrieving the terms of said instrument;
(o) retrieving the details of said trade;
(p) evaluating the value of the quantity of the instrument by applying said market data to the terms of said instrument and said trade details to determine value and any interest due to complete a mark to market process, as of a selected effective date, and output a set of marks saved into the database in a marks table;
(q) allowing a user the ability to enter in marks for the terms of said instrument and said trade details in to the marks table, which marks may vary from those determined by the above application of market data to the terms of said instrument and said trade details, wherein said marks express the opinion of said user with respect to the value of said instrument;
(r) applying the terms of the instrument and said trade details, said market data, and said set of marks to a set of data requests and calculation instructions to output data responsive to said data requests in the form of annotated trade events related to instruments in said internal account, said annotated trade events being output in the form of output variable-value pairs associated with a particular instrument and other information comprising annotated trade event identification information, whereby variable-value pairs express such things as present value, interest paid to date, interest received to date, interest due to be paid, interest due to be received, and the like;
(s) beginning to process trade events by ordering the application of Meta account rules based upon standard accounting practices such that there is a logical ordering of account processing;
(t) designating a designated place in memory for receiving specified items of information needed to form a ledger balance;
(u) reading the first annotated trade event from memory;
(v) evaluating said first annotated trade event and applying the applicable Meta account rules to determine if there is an offset;
(w) reordering the application of Meta account rules if such reordering is required by the existence of an offset;
(x) assembling information called for by the first Meta account rule for calculating the balances affected by the first annotated trade event;
(y) associating said annotated trade event with all other annotated trade events to which it is matched whereby the position associated with said trade event is reduced by a percentage if there is a match, where a match is defined by a Meta account matching rule and ordering said associated trade events on a first-in, first-out basis;
(z) computing the percentage of a trade that is matched if said trade has been matched;
(aa) based upon annotated trading events and applicable Meta account rules, computing a balance and storing the same in said designated place in memory for receiving specified items of information to form a ledger balance;
(bb) repeating steps w, x and y for all other Meta accounts;
(cc) repeating steps t, u, v, w, x, y and z for all annotated trade events;
(dd) forming a set of the balances for the effective date;
(ee) optionally masking trade details;
(ff) generating a set of balances for all days prior to the effective date;
(gg) polling all journal entry batches posted for said internal account being processed prior to said effective date and calculating and constructing a historical set of balances;
(hh) comparing said set of balances to said historical set of balances to obtain a difference;
(ii) generating journal entries based on said sets of balances if said difference does not equal zero;
(jj) writing said journal entries;
(kk) posting said journal entries in the form of batches of journal entries which are saved to a database containing all journal entry batches previously posted;
(ll) optionally determining if the user has required further processing;
(mm) if said user has required further processing, employing a scripted set of rules and selecting a first set of information from said posted journal entry batches;
(nn) employing said scripted set of rules to select a second set of information from said posted journal entry batches or other information derived from saidjournal entry batches;
(oo) evaluating said first and second sets of information with respect to each other to determine whether a further operation is required; and
(pp) performing said further operation.

2. An accounting process of the type employing a general ledger which is broken out into a plurality of subledgers which in turn are broken out into a number of accounts, some of said accounts being parent accounts, which parent accounts are broken out into child accounts, wherein the improvement comprises that said subledgers have accounting rules associated with them, said accounts have accounting rules associated with them, and said child accounts have accounting rules associated with them, the above accounting rules being referred to as Meta accounts, the collection of all Meta accounts being referred to as a master account, said process comprising the steps of:
(a) outputting to the user an interface calling for trade information;
(b) inputting into said interface the name of an instrument having desired terms corresponding to those which one desires to implement in a particular trade;
(c) entering the trade date associated with said trade;
(d) entering the settle date associated with said trade;
(e) entering the trade quantity associated with said trade;
(f) entering the price associated with said trade;
(g) entering a dealer name and any other optional information associated with said trade;
(h) entering an allocation, said the allocation being symbolized by an allocation name, such as deutsche mark hedged or deutsche mark hedging, and said allocation having an attribute of being a hedging or a hedged trade, and a descriptive strategy denominator, such as deutsche mark currency, said settle date, trade quantity, price, dealer name, allocation and any other optional information comprising trade details;
(i) saving said trade details to a database, said database storing information respecting a plurality of instruments associated with a particular internal account;
(j) repeating steps a through i for a plurality of trades and compiling and storing market data relating to said instrument;
(k) downloading market data daily and saving the same in a database of historical market data;
(l) retrieving the terms of said instrument;
(m) retrieving the details of said trade;
(n) evaluating the value of the quantity of the instrument by applying said market data to the terms of the instrument and said trade details to determine value and any interest due to complete a mark to market process, as of a selected effective date, and output a set of marks saved into the database in a marks table;
(o) allowing a user the ability to enter in marks for the terms of said instrument and said trade details, which marks vary from those determined by the above application of market data to the terms of said instrument and said trade details, wherein said marks express the opinion of said user with respect to the value of said instrument;
(p) applying said market data, the terms of the instrument and said trade details, and said set of marks to a set of data requests and calculation instructions to output data responsive to said data requests in the form of annotated trade events related to instruments in said internal account, said annotated trade events being output in the form of output variable-value pairs associated with a particular instrument and other information comprising annotated trade event-identification information, whereby variable-value pairs express such things as present value, interest paid to date, interest received to date, interest due to be paid, interest due to be received, and the like;
(q) beginning to process trade events by ordering the application of Meta account rules based upon a logical ordering of Meta account rules based on standard accounting practices;
(r) designating a designated place in memory for receiving specified items of information to form a ledger balance;
(s) reading the first annotated trade event from memory;
(t) evaluating said first annotated trade event and by applying the applicable Meta account rules to determine if there is an offset;
(u) reordering the application of Meta account rules if such reordering is required by the existence of an offset;
(v) assembling information called for by the first Meta account rule for calculating the balances affected by the first annotated trade event;
(w) associating said annotated trade event with all other annotated trade events to which it is matched whereby the position associated with said trade event is reduced by a percentage if there is a match, where a match is defined by a Meta account matching rule and ordering said associated trade events on a first-in, first-out basis;
(x) computing the percentage of a trade that is matched if said trade has been matched;
(y) based upon annotated trading events and applicable Meta account rules, computing a balance and storing the same in said designated place in memory for receiving specified items of information to form a ledger balance;
(z) repeating steps w, x and y for all other Meta accounts;
(aa) repeating steps t, u, v, w, x, y and z for all annotated trade events;
(bb) forming a set of the balances for the effective date;
(cc) optionally masking trade details;
(dd) generating a set of balances for all days prior to the effective date;
(ee) polling all journal entry batches posted for said internal account being processed prior to said effective date and calculating and constructing a historical set of balances;
(ff) comparing said set of balances to said historical set of balances to obtain a difference;
(gg) generating journal entries based on said sets of balances if said difference does not equal zero;
(hh) writing said journal entries;
(ii) posting said journal entries in the form of batches of journal entries which are saved to a database containing all journal entry batches previously posted;
(jj) optionally determining if the user has required further processing;
(kk) if said user has required further processing, selecting a first set of information from said posted journal entry batches;
(ll) selecting a second set of information from said posted journal entry batches or other information derived from said journal entry batches;
(mm) evaluating said first and second sets of information with respect to each other to determine whether a further operation is required; and
(pp) performing said further operation.
